(19) United States
(12) Patent Application Publication
(10) Pub. No.: US 2013/0106824 A1
(43) Pub. Date: May 2, 2013

(54) DATA SIGNAL LINE DRIVING CIRCUIT, DISPLAY DEVICE, AND DATA SIGNAL LINE DRIVING METHOD

(71) Applicant: Yoshimitsu Yamauchi, Osaka-shi (JP)

(72) Inventor: Yoshimitsu Yamauchi, Osaka-shi (JP)

(73) Assignee: SHARP KABUSHIKI KAISHA, Osaka-shi, Osaka (JP)

(21) Appl. No.: 13/809,942

(22) PCT Filed: May 16, 2011
(86) PCT No.: PCT/JP2011/061168

§ 371 Date: Jan. 14, 2013

(30) Foreign Application Priority Data
Jul. 15, 2010 (JP) 2010-160242

(51) Int. Cl. G09G 5/00

(52) U.S. Cl. CPC G09G 5/00
USPC 345/211; 345/92

(57) ABSTRACT

A liquid crystal display device includes a data signal line driving circuit which separately drives data signal lines of an active matrix pixel array. One vertical period is divided into a scanning period and a non-scanning period. The data signal line driving circuit applies a signal voltage corresponding to the pixel data having the same polarity to the same data signal line with a predetermined fixed potential as a reference regardless of an order of a selected scanning signal line in the scanning period, and applies an intermediate voltage between maximum and minimum values of pixel voltages to each data signal line in the non-scanning period, the pixel voltages being respectively held in the pixel electrodes of the pixels connected to each data signal line.

### CROSS-REFERENCE TO RELATED APPLICATIONS

This application is a National Phase filing under 35 U.S.C. § 371 of International Application No. PCT/JP2011/061168 filed on May 16, 2011, and which claims priority to Japanese Patent Application No. 2010-160242 filed on Jul. 15, 2010.

### TECHNICAL FIELD

The present invention relates to an active matrix liquid crystal display device, and particularly relates to a data signal line driving circuit and a data signal line driving method.

FIG. 12 illustrates an equivalent circuit of each pixel constituting a pixel array of a common active matrix liquid crystal display device. Further, FIG. 13 illustrates an example of a circuit arrangement in an active matrix liquid display device of m x n pixels. As illustrated in FIG. 13, a switching element formed with a thin film transistor (TFT) is provided at each intersection of m source lines (data signal lines) and n scanning lines (scan signal lines) and, as illustrated in FIG. 12, a liquid crystal element LC and an auxiliary capacitive element Cs are connected in parallel through the TFT. The liquid crystal element LC has a layered structure in which a liquid crystal layer is provided between a pixel electrode and an opposite electrode (common electrode). In addition, FIG. 13 briefly illustrates only a TFT and a pixel electrode (black rectangular portion) of each pixel circuit. In the auxiliary capacitive element Cs, one end is connected to the pixel electrode and the other end is connected to a capacity line LCs to stabilize a pixel data voltage held in the pixel electrode. The auxiliary capacitive element Cs provides an effect of suppressing fluctuation of the pixel data voltage held in the pixel electrode due to a leak current of a TFT, fluctuation of an electrical capacitance of the liquid crystal element LC between black display and white display due to dielectric anisotropy of liquid crystal particles, and voltage fluctuation caused by parasitic capacitance between the pixel electrode and a surrounding wiring. By sequentially controlling voltages of scanning lines, the TFTs connected to one scanning line enter a conducted state, and the pixel data voltages supplied to respective source lines are written in corresponding pixel electrodes with respect to each scanning line.

Even when display content is a still image upon normal display of full color display, by repeatedly writing the same display content in the same pixel with respect to each frame while inverting the voltage polarity applied to the liquid crystal element LC, the pixel data voltage held in the pixel electrode is updated, voltage fluctuation of pixel data is minimized, and high quality still image display is secured. The action, in which pixel data is written while the voltage polarity applied to the liquid crystal element LC is inverted, is referred to as a “polarity inversion drive” hereinafter.

Power consumption for driving a liquid crystal display device is mostly occupied by power consumption for driving source lines by a source driver, and can be roughly expressed by a relational expression shown in following Mathematical Expression 1. In Mathematical Expression 1, P represents power consumption, f represents a refresh rate (the number of times of refresh operations in one frame per unit time), C represents a load capacitance driven by a source driver, V represents a driving voltage of the source driver, n represents the number of scanning lines and m represents the number of source lines. In addition, the refresh operation is directed to canceling fluctuation produced in a voltage (absolute value) corresponding to pixel data applied to the liquid crystal element LC by writing the pixel data again, and returning the voltage to the original voltage state corresponding to the pixel data.

Mathematical Expression 1

P∝f·C·V₂·n·m

Meanwhile, in the case of constantly displaying a still image, or in the case of displaying a moving image with a slow motion, pixel data is not necessarily updated at the same refresh rate (normally 60 Hz) as a normal display, and a decrease in refresh rate has been made to further reduce power consumption of the liquid crystal display device. For example, as disclosed in Patent Document 1 listed below, low power consumption by means of a low frequency intermittent drive has been sought by dividing one vertical period into a scanning period and a breaking period and setting the scanning period to the time corresponding to the normal 60 Hz. However, when the refresh rate is decreased, a pixel voltage held in a pixel electrode fluctuates due to a leak current of a TFT. Further, since an average potential also decreases during each frame period, the voltage fluctuation becomes a fluctuation in display luminance of each pixel (transmittance of the liquid crystal), and is observed as flicker at the time of polarity inversion. Moreover, this might cause deterioration in display quality, such as insufficient contrast.

Meanwhile, for example, Patent Documents 2 and 3 disclose configurations as a method of solving a problem that display quality decreases due to a decrease in the refresh rate. According to the configurations disclosed in Patent Documents 2 and 3, a switching element of a pixel illustrated in FIG. 12 is formed with a series circuit of two TFTs (transistors T1 and T2), an intermediate node N2 between the two TFTs is driven to have the same potential as a pixel electrode N1 using a buffer amplifier 50 of a unity gain, and a problem that display quality decreases is solved by substantially suppressing the leak current of the TFT by preventing the voltage from being applied between a source and a drain of the TFT (T2) arranged on a pixel electrode side (see FIGS. 14 and 15).

This is a solution method which takes into account a substantial increase in the leak current of the TFT following an increase in a bias voltage between the source and the drain. As illustrated in FIGS. 14 and 15, according to the configurations disclosed in Patent Documents 2 and 3, although the bias voltage between the source and the drain increases in the TFT (T1) connected to the source line SL and the leak current of the TFT is likely to increase, the leak current is compensated for by the buffer amplifier 50 and does not influence the pixel voltage held in the pixel electrode Ni. According to this configuration with the buffer amplifier 50, a problem that display quality decreases due to a decrease in the refresh rate is solved, and power consumption is further reduced due to a decrease in the refresh rate. Further, the configurations disclosed in Patent Documents 2 and 3 can support two or more different voltage states as the pixel voltage held in the pixel electrode, and can realize high quality constant display having multiple tones with low power consumption.

### PRIOR ART DOCUMENT

### Patent Document

Patent Document 1: Japanese Patent Application Laid-Open Publication No. 2001-312253

Patent Document 2: Japanese Patent Application Laid-Open Publication No. 5-142573

Patent Document 3: Japanese Patent Application Laid-Open Publication No. 10-62817

### SUMMARY OF THE INVENTION

### Problems to be Solved by the Invention

Due to proliferation of digital contents (advertisements, news, electronic books, and the like) with the development of the communication infrastructure, a transmissive liquid crystal display device has been required which can make full-color displays with low power consumption with respect to a variety of images such as a still image and moving images at different drawing rates in image displays of the digital contents by portable information terminals such as a mobile phone and a mobile internet device (MID). However, in the case of a configuration provided with a buffer amplifier in units of pixels and in the case of a configuration provided with a memory circuit such as SRAM as disclosed in Patent Documents 2 and 3, an aperture ratio decreases with increase in the number of elements and signal lines constituting the circuit, thereby making a full-color display difficult. Meanwhile, although the low frequency intermittent drive as disclosed in Patent Document 1 is effective for achieving low power consumption, there has been a problem in that fluctuations in pixel voltage due to a leak current of the TFT is viewed as flicker at the time of polarity inversion as described above.

The present invention has been made in view of the above problems, and an object thereof is to provide a liquid crystal display device capable of making full-color displays with low power consumption and high display quality with respect to a moving image and a still image.

### Means for Solving the Problem

In order to achieve the above object, the present invention provides a data signal line driving circuit or a data signal line driving method which separately drives a plurality of data signal lines of an active matrix pixel array, wherein

each pixel constituting the pixel array includes:

a unit display element that presents a different display state in accordance with a pixel voltage held in a pixel electrode; and

a thin-film transistor element including a first terminal, a second terminal, and a control terminal that controls conduction/non-conduction between the first and second terminals, the first terminal being electrically connected to the pixel electrode, the second terminal being electrically connected to any one of the plurality of data signal lines extending in a column direction, the control terminal being electrically connected to any one of a plurality of scanning signal lines extending in a row direction,

a scanning period is one successive period set within one vertical period when pixel data are written into all pixels of the pixel array, wherein the plurality of scanning signal lines are sequentially selected and the pixel data are written into the pixels connected to each sequentially selected scanning signal line,

a non-scanning period is another successive period set within the one vertical period, wherein the plurality of scanning signal lines are not selected and the pixel data written during the scanning period are separately held in the pixels, and

the data signal line driving circuit

applies a signal voltage corresponding to the pixel data having the same polarity to the same data signal line with a predetermined fixed potential as a reference regardless of an order of the selected scanning signal line in the scanning period, and

applies an intermediate voltage between a maximum value and a minimum value of pixel voltages to each of the data signal lines in the non-scanning period, the pixel voltages being respectively held in the pixel electrodes of the plurality of pixels connected to each of the data signal lines.

Furthermore, as for the data signal line driving circuit or the data signal line driving method having the above characteristics, it is preferred that the unit display element be a unit liquid crystal display element formed by holding a liquid crystal layer between the pixel electrode and an opposite electrode.

Furthermore, as for the data signal line driving circuit or the data signal line driving method having the above characteristics, it is preferred that in the non-scanning period, one common intermediate voltage be applied to the data signal lines to which the signal voltages having the same polarity are applied in the scanning period, the one common intermediate voltage being set in accordance with the polarity, and the common intermediate voltage be given as an average value of two pixel voltages corresponding to a maximum gradation and a minimum gradation of the pixel data, respectively.

Furthermore, as for the data signal line driving circuit or the data signal line driving method having the above characteristics, it is preferred that in the scanning period, the signal voltage having a positive polarity is applied to one of the two adjacent data signal lines with the fixed potential as a reference, while the signal voltage having a negative polarity is applied to the other of the two adjacent data signal lines with the fixed potential as the reference, and in the scanning period in the subsequent one vertical period, the polarities of the signal voltages are inverted.

Furthermore, as for the data signal line driving circuit or the data signal line driving method having the above characteristics, it is preferred that a length of the scanning period be not more than one-half of a length of the one vertical period, and the length of the scanning period within the one vertical period be shorter than 8.34 msec.

Furthermore, as for the data signal line driving method having the above characteristics, it is preferred that timing control information in accordance with an attribute of an image displayed in the pixel array be received, and a length of at least any one of the scanning period and the non-scanning period be set based on the timing control information.

Furthermore, in order to achieve the above object, the present invention provides a display device comprising:

a pixel array in which a plurality of pixels are arranged in a row direction and a column direction, respectively, the plurality of pixels each including
a unit display element that presents a different display state in accordance with a pixel voltage held in a pixel electrode, and
a thin-film transistor element including a first terminal, a second terminal, a control terminal that controls conduction/non-conduction between the first and second terminals, the first terminal being electrically connected to the pixel electrode, the second terminal being electrically connected to any one of the plurality of data signal lines extending in the column direction, the control terminal being electrically connected to any one of a plurality of scanning signal lines extending in the row direction;

the data signal line driving circuit having the above characteristics; and

a scanning signal line driving circuit, wherein

a scanning period is set within one vertical period when pixel data are written into all pixels of the pixel array, wherein the plurality of scanning signal lines are sequentially selected and the pixel data are written into the pixels connected to each sequentially selected scanning signal line,

a non-scanning period is set within the one vertical period, wherein the plurality of scanning signal lines are not selected and the pixel data written during the scanning period are separately held in the pixels, and

the scanning signal line driving circuit

applies a first scanning voltage that sets the thin-film transistor element to a conducting state to the selected scanning signal line and a second scanning voltage that sets the thin-film transistor element to a non-conducting state to an unselected scanning signal line in the scanning period, and

applies a non-scanning voltage that sets the thin-film transistor element to a non-conducting state to all of the scanning signal lines.

Furthermore, as for the display device having the above characteristics, it is preferred that the unit display element be a unit liquid crystal display element formed by holding a liquid crystal layer between the pixel electrode and an opposite electrode, and the display device include an opposite electrode driving circuit which supplies the opposite electrode with a counter electrode voltage fixed within a predetermined voltage range with the fixed potential as a reference throughout a successive plurality of vertical periods. In addition, it is preferred that the pixel is provided without an auxiliary capacitive element having one end connected to the pixel electrode.

Furthermore, it is preferred that the display device having the above characteristics comprise a display control circuit which receives timing control information in accordance with an attribute of an image displayed in the pixel array, and sets a length of at least one of the scanning period and the non-scanning period based on the timing control information, to perform timing control on the data signal line driving circuit and the scanning signal line driving circuit based on the set scanning period and non-scanning period.

Furthermore, it is preferred that the display device having the above characteristics comprise the scanning signal lines the number of which is equal to the number of rows of the pixel array, and the data signal lines the number of which is greater by one than the number of columns of the pixel array, wherein

in each of the pixels arranged in the same row of the pixel array, the control terminal of the thin-film transistor element is connected to the scanning signal line in the same row order as the relevant row,

in each of the pixels arranged in the same column of the pixel array in one of odd-numbered and even-numbered row orders, the second terminal of the thin-film transistor element is connected to the data signal line in the same column order as the relevant column, and

in each of the pixels arranged in the same column of the pixel array in the other of odd-numbered and even-numbered row orders, the second terminal of the thin-film transistor element is connected to the data signal line in a column order greater by one than the same column order as the relevant column (the first pixel array configuration).

Furthermore, it is preferred that the display device having the above characteristics comprise the scanning signal lines the number of which is equal to the number of rows of the pixel arrays and the data signal lines the number of which is equal to the number of columns of the pixel arrays, wherein

in each of the pixels arranged in the same row of the pixel array, the control terminal of the thin-film transistor element is connected to the scanning signal line in the same row order as the relevant row, and

in each of the pixels arranged in the same column of the pixel array, the second terminal of the thin-film transistor element is connected to the data signal line in the same column order as the relevant column (the second pixel array configuration).

### EFFECTS OF THE INVENTION

According to the data signal line driving circuit, the data signal line driving method, or the display device, having the above characteristics, polarities of a signal voltage and an intermediate voltage are constant with respect to each data signal line, the voltages being applied to each data signal line within one vertical period with a predetermined fixed potential (which is fixed to a constant potential throughout a plurality of successive vertical periods, such as a ground potential) as a reference. Therefore, in a non-scanning period, the maximum value of a bias voltage (absolute value) that is applied between first and second terminals (between a source and a drain) of each of thin-film transistor elements of a plurality of pixels connected to the same data signal line can be decreased to not more than the order of ¼ of the maximum value of a bias voltage that is applied to the same pixel during a scanning period. Further, the maximum value of the bias voltage can be decreased to not more than the order of ½ of the maximum value of the bias voltage that is applied to the same pixel in the non-scanning period (breaking period) in the conventional low frequency intermittent drive disclosed in Patent Document 1. Since a source-drain leak current of the thin-film transistor element can be significantly suppressed by reducing the source-drain bias voltage, fluctuations in pixel voltage associated with the source-drain leak current of the thin-film transistor element in one pixel is generated only in the scanning period and is suppressed in the non-scanning period. Accordingly, as compared with a typical normal display in which one vertical period is wholly the scanning period, power consumption required for driving the data signal line does not change since the refresh rate is the same in the one same vertical period. However, in the present invention, the scanning period becomes shorter than that in the typical normal display and the time when the pixel voltage changes due to the leak current thus becomes shorter, whereby a fluctuation amount of the pixel voltage is suppressed and the flicker visibility is reduced, so as to improve the display quality. On the other hand, when assuming that the scanning period is the same length as one vertical period in the normal display and one vertical period becomes longer by the time corresponding to the non-scanning period, since the one vertical period becomes longer than the typical normal display and the refresh rate decreases, power consumption required for driving the data signal line becomes smaller and fluctuations in pixel voltage in the additional non-scanning period is suppressed, leading to suppression of deterioration in display quality and achievement of low power consumption. Further, as compared with the conventional low frequency intermittent drive, fluctuations in pixel voltage in the non-scanning period is further suppressed with use of the same refresh rate, the flicker visibility is reduced to allow improvement in display quality as well as a longer non-scanning period, and hence it is possible to achieve lower power consumption in the case of keeping the display quality at the same level. As an example, with the one vertical period in the typical normal display being 1/60 sec (about 16.67 msec), making the scanning period of the present invention not more than ½ thereof (shorter than 8.34 msec) allows temporal suppression of fluctuations in pixel voltage during the scanning period, thus leading to reduction in flicker visibility to improve the display quality. Further, the non-scanning period can be made longer due to fluctuations in pixel voltage during the scanning period being suppressible, whereby it is possible to decrease the refresh rate with respect to a still image and a moving image with a slow change, so as to achieve low power consumption. It is therefore possible to achieve low power consumption in accordance with an attribute (necessary drawing rate) of an image to be displayed, while improving the display quality.

Further, in a high gradation display such as a full-color display, when a unit display element is a unit liquid crystal display element, in the non-scanning period, a pixel voltage in a halftone voltage region is applied to the data signal line as an intermediate voltage. The halftone voltage region is a region where a liquid crystal transmittance is most susceptible to a liquid crystal application voltage in characteristics between the liquid crystal transmittance and the liquid crystal application voltage that is applied between the pixel electrode and an opposite electrode. Therefore, a bias voltage that is applied between the source and the drain of the thin-film transistor element of a pixel that holds the halftone voltage becomes 0 V or a value in the vicinity thereof, to thereby significantly suppress the source-drain leak current of the pixel. That is, in the voltage region where the liquid crystal transmittance is most changeable, the leak current as a factor of fluctuations in pixel voltage can be more effectively suppressed, thus leading to improvement in holding characteristics of pixel data with respect to a pixel that holds halftone pixel data susceptible to fluctuations in liquid crystal transmittance. This results in improvement in holding characteristics of pixel data throughout the pixels in the full-color display, and significant improvement in display quality.

Further, since the foregoing effect can be exerted on the conventional pixel, for example, a particular circuit for reducing a bias voltage as disclosed in Patent Documents 2 and 3 is not required to be added, and a liquid crystal display device capable of making a full-color display with low power consumption with respect to a still image and a motion without sacrificing an aperture ratio of each pixel can be provided.

In the non-scanning period, an intermediate voltage that is applied to each data signal line may be taken, with respect to each data signal line, as an intermediate voltage (hereinafter, referred to as “individual intermediate voltage” for convenience) of the maximum value and the minimum value of each pixel voltage which were written in a plurality of pixels connected to the data signal line during the last scanning period and are actually held. In this case, the individual intermediate voltage that is applied with respect to each data signal line is required to be derived based on pixel data with respect to each data signal line which has been written in the last scanning period. Thereat, a common intermediate voltage is derived as an average value of two pixel voltages corresponding to the maximum gradation and the minimum gradation of the pixel data with respect to each polarity of the signal voltage that is applied in the scanning period, and the same common intermediate voltage is applied to data signal lines to which the signal voltages having the same polarity are applied, to thereby simplify application processing of the intermediate voltage in the non-scanning period. Even in the case of using the common intermediate voltage, the above reduction in bias voltage (not more than the order of ¼ of the maximum value in the scanning period and not more than the order of ½ of the maximum value in the non-scanning period in the conventional low frequency intermittent drive) can be ensured, and in the case of using the individual intermediate voltage, the decrease in bias voltage can further be sought in accordance with pixel data actually written with respect to each data signal line. However, when the pixel data that are written into the pixel connected to one data signal line at least includes two pieces of pixel data of the maximum gradation and the minimum gradation, the individual intermediate voltage is equal to the common intermediate voltage with regard to the data signal line.

Herein, in the scanning period, one of two adjacent data signal lines is applied with a positive signal voltage while the other thereof is applied with a negative signal voltage, and in the scanning period of the next one vertical period, the polarities of the signal voltages are inverted, thereby allowing a more effective column inversion drive (which may also be referred to as a vertical line inversion drive) or a dot inversion drive due to reduction in flicker visibility in accordance with a configuration of a pixel array to be used, in addition to a frame inversion drive for inverting the pixel voltage for one frame with respect to each frame. Specifically, the dot inversion drive can be realized with respect to the first pixel array configuration, and the column inversion drive can be realized with respect to the second pixel array configuration. In should be noted that the dot inversion drive is more preferred for reduction in flicker visibility.

Further, in the case of a configuration in which each pixel constituting the pixel array is not provided with an auxiliary capacitive element (which corresponds to an auxiliary capacitive element Cs illustrated in FIG. 12), a charge amount held in the pixel electrode decreases, and hence a fluctuation amount of the pixel voltage increases when the source-drain leak current of the thin-film transistor element is the same. However, a load of the thin-film transistor element at the time of writing decreases, thereby allowing a shortened scanning period. That is, when there is no auxiliary capacitive element, a total capacity of the pixel electrode decreases by an amount corresponding thereto as compared with the case where the auxiliary capacitive element is present. On the contrary, since the scanning period can be reduced, the fluctuation amount of the pixel voltage can be suppressed. Further, by not providing the auxiliary capacitive element, it is not necessary to provide an auxiliary electrode which is opposed to the pixel electrode for constituting the auxiliary capacitive element and auxiliary signal wiring, whereby the aperture ratio of the pixel is improved. For example, in the case of writing pixel data at a higher rate (e.g., double rate being 120 Hz) than the normal refresh rate (60 Hz), it is possible to make a full-color moving image display with suppressed fluctuations in pixel voltage in a reduced scanning period, and with high display quality. Even in a configuration in which the auxiliary capacitive element is not provided, the fluctuations in pixel voltage can be suppressed by reducing the scanning period, and hence the device is naturally applicable to a low frequency intermittent drive with a lowered refresh rate, so as to provide a liquid crystal display device capable of making a full-color display with low power consumption with respect to a still image and a motion.

### BRIEF DESCRIPTION OF THE DRAWINGS

FIG. 1 is a block diagram illustrating an example of a schematic configuration of a display device according to an embodiment of the present invention.

FIG. 2 is an equivalent circuit diagram schematically illustrating an example of a pixel used in the display device illustrated in FIG. 1.

FIG. 3 is an equivalent circuit diagram schematically illustrating a configuration example of a pixel array used in the display device illustrated in FIG. 1.

FIG. 4 is an equivalent circuit diagram schematically illustrating another configuration example of a pixel array used in the display device illustrated in FIG. 1.

FIG. 5 is a characteristic diagram illustrating a relation between a drain current and a gate voltage of a polysilicon TFT.

FIG. 6 is a characteristic diagram illustrating a relation between a drain current and a gate voltage of an amorphous silicon TFT.

FIG. 7 is a timing diagram schematically illustrating an example of voltage application waveforms at the time of a write operation and a holding operation of the display device illustrated in FIG. 1.

FIG. 8 is a timing diagram schematically illustrating an example of voltage application waveforms at the time of a write operation in a comparative example not provided with a non-scanning period.

FIG. 9 is a timing diagram schematically illustrating an example of voltage application waveforms at the time of a write operation and a holding operation in a comparative example with a different voltage application condition in the non-scanning period.

FIG. 10 is a timing diagram schematically illustrating an example of voltage application waveforms at the time of a write operation and a holding operation in the comparative example in the case of performing a dot inversion drive in a pixel array configuration illustrated in FIG. 4.

FIG. 11 is a circuit diagram schematically illustrating a schematic configuration of an intermediate voltage driving circuit in another embodiment of the present invention.

FIG. 12 is an equivalent circuit diagram of a pixel of a common active matrix liquid crystal display device.

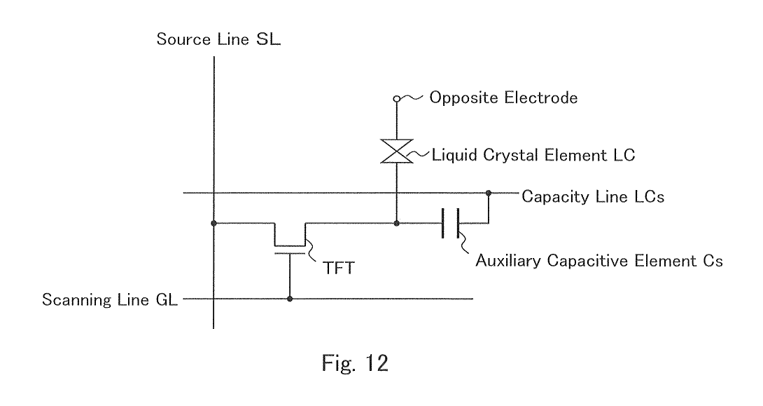

FIG. 13 is a block diagram illustrating an example of a circuit arrangement in an active matrix liquid display device of m x n pixels.

FIG. 14 is an equivalent circuit diagram illustrating an example of a conventional pixel having a buffer amplifier of a unity gain.

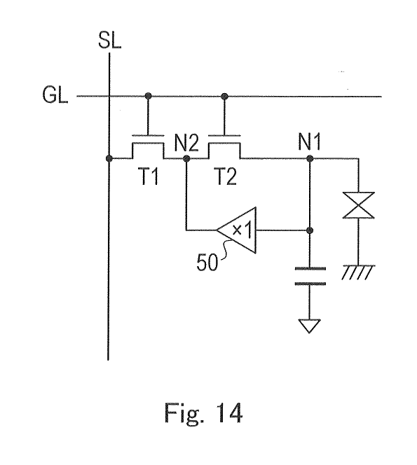

FIG. 15 is an equivalent circuit diagram illustrating another example of a conventional pixel having a buffer amplifier of a unity gain.

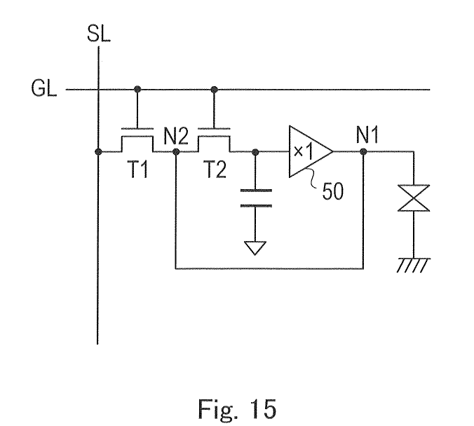

FIG. 16 is an equivalent circuit diagram schematically illustrating an example of a pixel used in the display device in another embodiment of the present invention.

### MODES FOR CARRYING OUT THE INVENTION

Hereinafter, an embodiment of a data signal line driving circuit and a display device according to the present invention will be described with reference to the drawings.

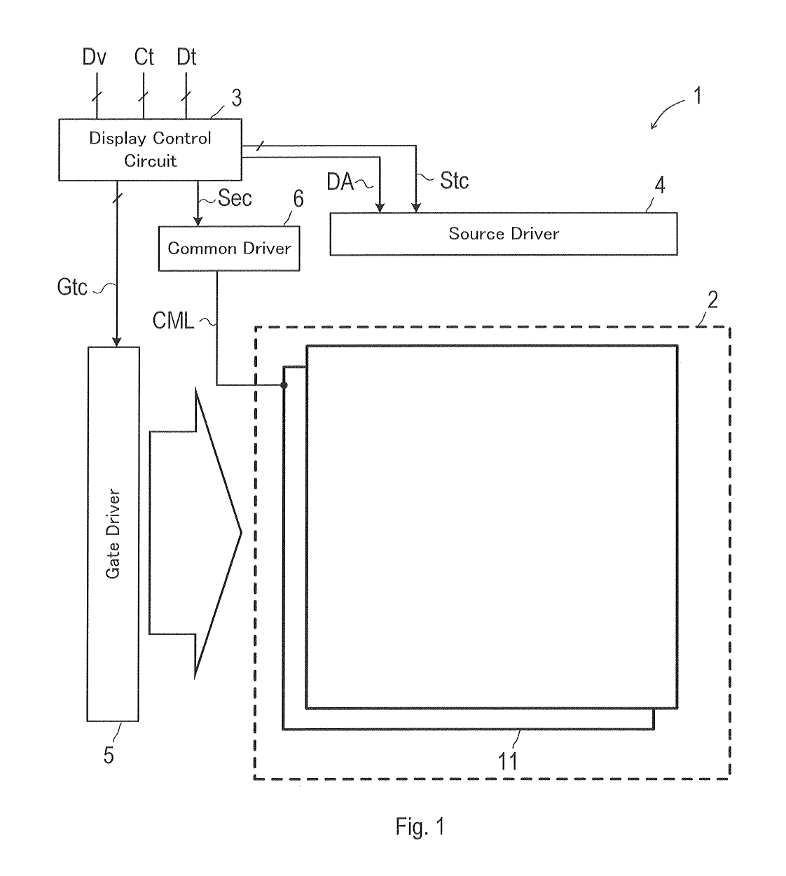

First, a system configuration of a display device of the present embodiment (hereinafter, simply referred to as a display device) will be described. As illustrated in FIG. 1, a display device 1 is provided with an active matrix liquid crystal panel 2, a display control circuit 3, a source driver 4, a gate driver 5, and a common driver 6. In addition, other than the above, the display device 1 is provided with a power supply circuit (not illustrated), and a backlight device (not illustrated) in the case where the liquid crystal panel 2 is a transmissive type (type with a pixel electrode configured by a transmissive electrode, a dual type (type with the pixel electrode having both a transmissive electrode region and a reflective electrode region) or a semi-transmissive type (type with one pixel electrode having both functions of the transmissive electrode and the reflective electrode). The source driver 4 corresponds to the data signal line driving circuit, the gate driver 5 corresponds to the scanning signal line driving circuit, and the common driver 6 corresponds to the opposite electrode driving circuit.

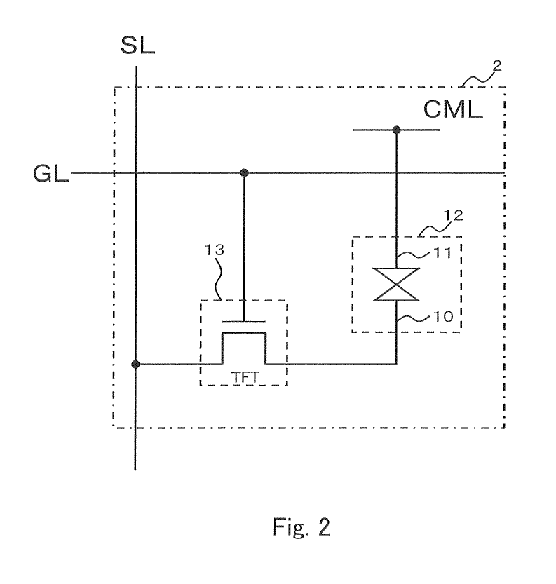

The liquid crystal panel 2 includes pixel arrays formed by arranging in a matrix a plurality of pixels respectively in a row direction and a column direction, a plurality of gate lines GL (corresponding to scanning signal lines) extending in the row direction, and a plurality of source lines SL (corresponding to data signal lines) extending in the column direction. As illustrated in the equivalent circuit of FIG. 2, each pixel is provided with a TFT (thin-film transistor element) 13 and a unit liquid crystal display element 12 formed by holding a liquid crystal layer between a pixel electrode 10 and an opposite electrode 11. A gate (control terminal) of the TFT 13 is connected to the gate line GL, a first terminal (drain) to the pixel electrode 10, and a second terminal (source) to the source line SL. In the present embodiment, there is assumed a configuration not provided with an auxiliary capacitive element, which is provided in a pixel of a typical active matrix liquid crystal panel. Accordingly, it is not necessary to provide an auxiliary capacitive electrode connected with the pixel electrode 10, and an auxiliary capacitive line opposed to the auxiliary capacitive electrode across an insulating film and extending in the row direction or the column direction on the auxiliary capacitive electrodes across a plurality of pixels, which are necessary for constituting the auxiliary capacitive element. This leads to simplification of the pixel structure as well as improvement in aperture ratio of the pixel. In the transmissive liquid crystal panel 2, both the pixel electrode 10 and the opposite electrode 11 are formed of light transmissive transparent conductive material such as ITO, the pixel electrode 10, the TFT 13, the gate line GL, and the source line SL are formed on a first transparent insulating substrate which is one of two transparent insulating substrates holding the liquid crystal layer, and the opposite electrode 11 is formed over an entire surface on the liquid crystal layer side of a second transparent insulating substrate which is the other of the two substrates. Other than the above, a color filter is provided on the liquid crystal layer side of the second transparent insulating substrate and a phase difference plate, a polarization plate, a reflection preventive film, and the like are provided on the outer side of the second transparent insulating substrate, but a liquid crystal panel having a conventionally known structure can be used as the liquid crystal panel 2 in the present embodiment, and a detailed description thereof will be omitted since the structure of the liquid crystal panel 2 is not the object of the present invention.

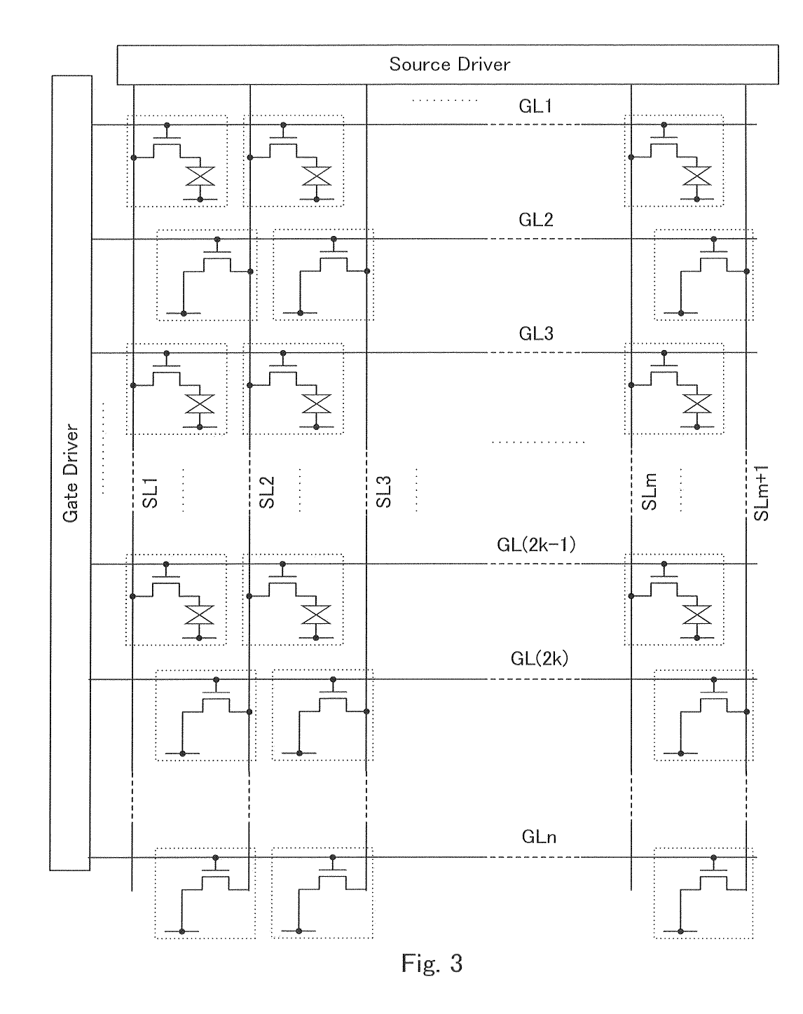

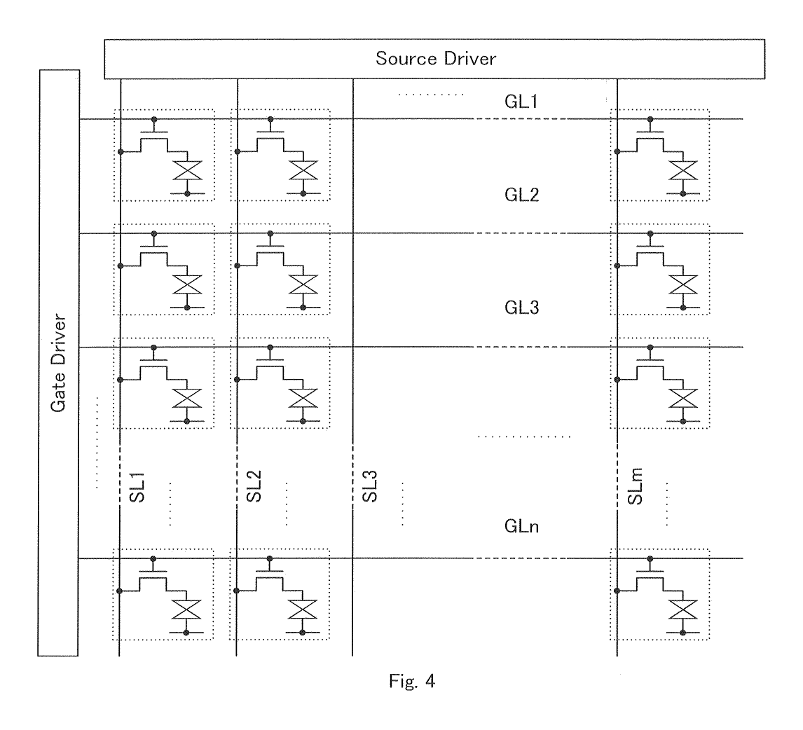

In the present embodiment, a below-mentioned dot inversion drive is realized using a pixel array configuration (first pixel array configuration) schematically illustrated in the equivalent circuit diagram of FIG. 3. As another embodiment, in the case of using the pixel array configuration (second pixel array configuration) schematically illustrated in the equivalent circuit diagram of FIG. 4, a below-mentioned column inversion drive is realized.

As illustrated in FIG. 3, the first pixel array configuration includes the gate lines (GL1, GL2, . . . , GLn) the number of which is equal to the number of rows n of the pixel array, and the source lines (SL1, SL2, . . . , SLm+1) the number of which is greater by one than the number of columns m of the pixel array, a gate (control terminal) of the TFT 13 of each pixel arranged in an i-th row (i=1 to n) is connected to a gate line GLi in the i-th row, a source (second terminal) of the TFT 13 of each pixel arranged in an odd-numbered row (2k−1: k=1 to (n+1)/2) of a j-th column (j=1 to m) is connected to a source line SLj in the j-th column, and a source (second terminal) of the TFT 13 of each pixel arranged in an even-numbered row (2k:k=1 to (n+1)/2) of the j-th column (j=1 to m) is connected to a source line SLj+1 of a (j+1)-th column. Herein, i, j, and k are each a natural number, m and n are each a natural number not smaller than 2, and (n+1)/2 is calculated by dropping a fractional portion of the number. FIG. 3 is a diagram assuming the case where the number of rows n is an even number.

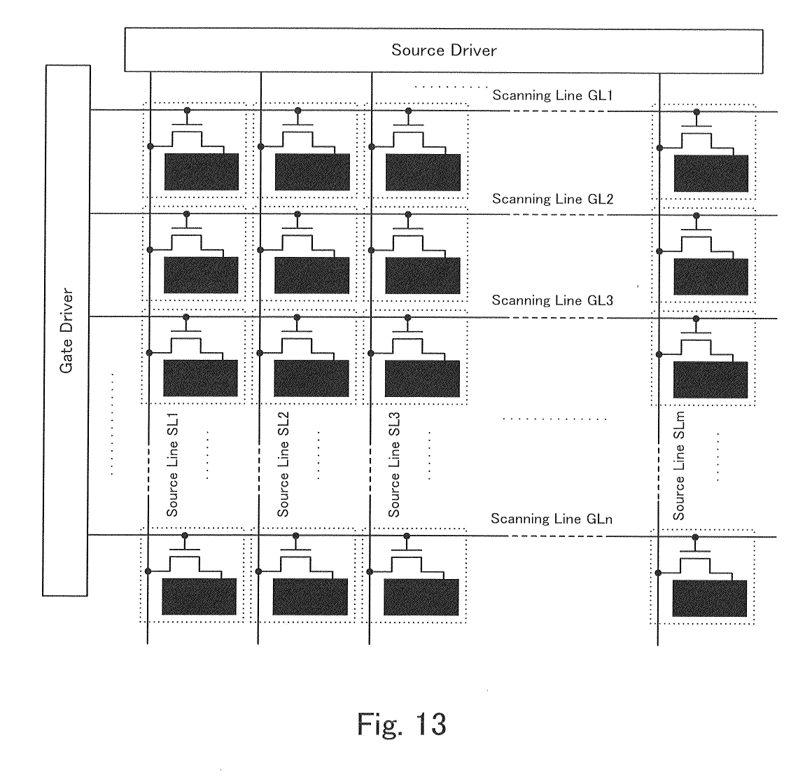

As illustrated in FIG. 4, the second pixel array configuration includes the gate lines (GL1, GL2, . . . , GLn) the number of which is equal to the number of rows n of pixel arrays, and the source lines (SL1, SL2, . . . , SLm) the number of which is equal to the number of columns m of pixel arrays, a gate (control terminal) of the TFT 13 of each pixel arranged in an i-th row (i=1 to n) is connected to a gate line GLi in the i-th row, and a source (second terminal) of the TFT 13 of each pixel arranged in a j-th column (j=1 to m) is connected to a source line SLj in the j-th column. Herein, i and j are each a natural number, and m and n are each a natural number not smaller than 2. The second pixel array configuration illustrated in FIG. 4 is basically the same as a pixel array configuration of a circuit arrangement example illustrated in FIG. 13.

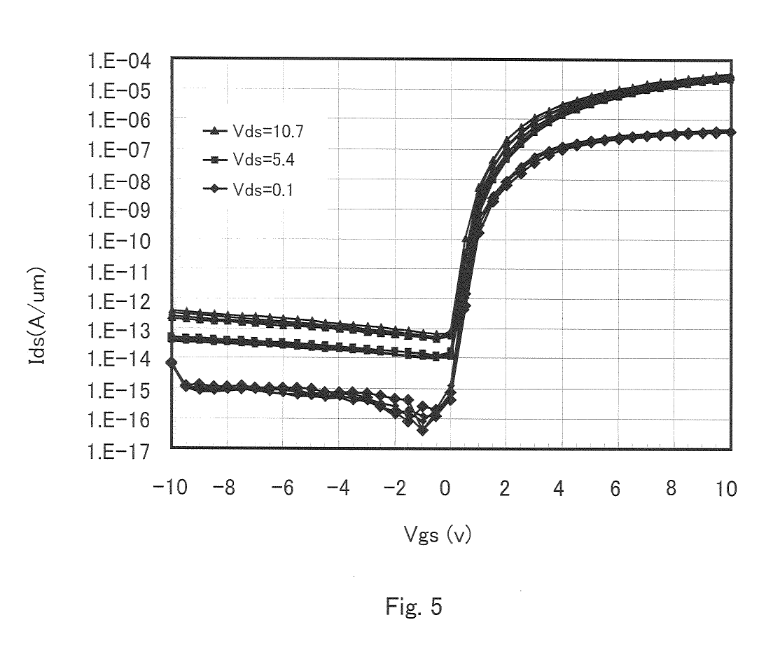

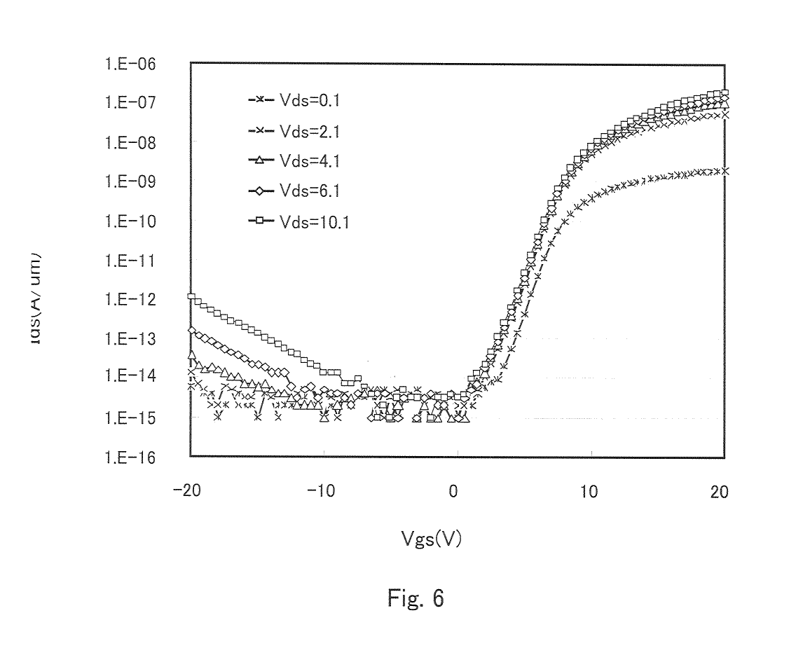

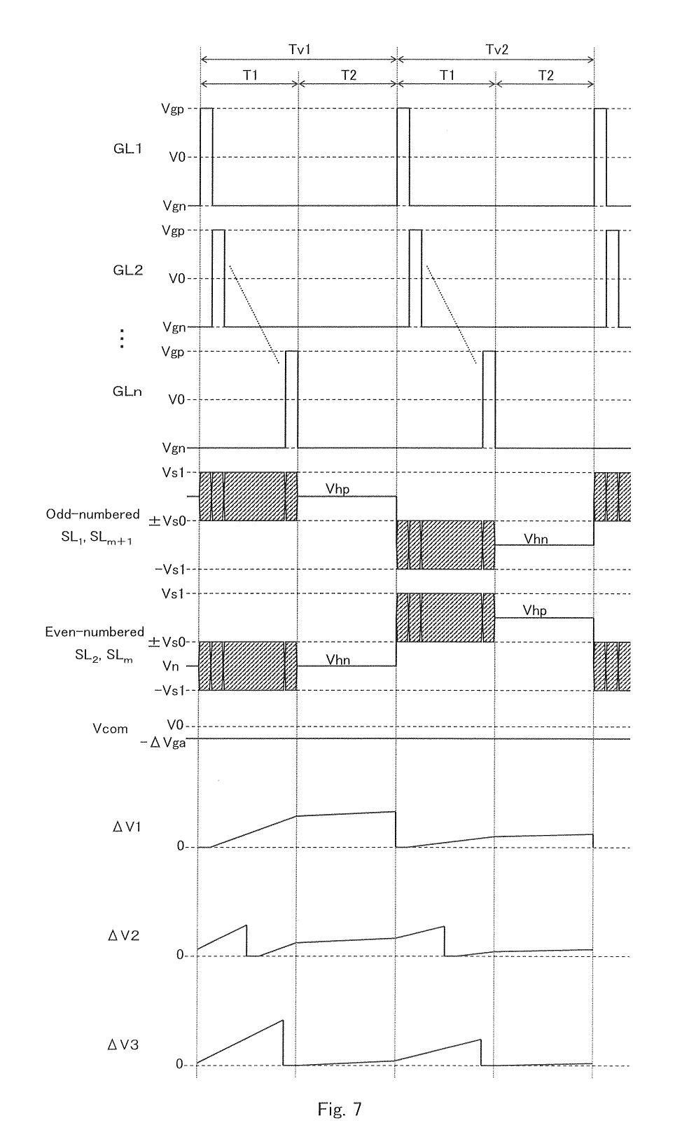

In the present embodiment, the use of an n-channel type polysilicon TFT or an amorphous silicon TFT as the TFT 13 is assumed, and as exemplified in FIGS. 5 and 6, these TFTs has leak current characteristics that a source-drain leak current at the time of turning-off (especially at the time of negative gate bias) changes depending on a source-drain bias voltage Vds. FIG. 5 illustrates an example of IV characteristics between the drain current (Ids) and the gate voltage (Vgs) of the polysilicon TFT. The characteristics are the same as characteristics disclosed in FIG. 7 of Patent Document 2 and FIG. 4 of Patent Document 3. FIG. 6 illustrates an example of IV characteristics between the drain current (Ids) and the gate voltage (Vgs) of the amorphous silicon TFT. Also in the characteristics illustrated in FIG. 6, the source-drain leak current tends to become high when a negative bias (absolute value) of the gate voltage becomes higher than |−5 V|, and the leak-current becomes higher as the source-drain bias Vds becomes higher. It should be noted that the characteristics illustrated in FIGS. 5 and 6 are each an example, and the electrical characteristics of the TFT 13 used in the present embodiment are not limited to the characteristics illustrated in FIGS. 5 and 6.

The display control circuit 3 is a circuit that controls a write operation and a holding operation which will be described later. The write operation is an operation of repeating, in each vertical period, a process of writing pixel data for one frame into each corresponding pixel inside the pixel array within one scanning period. In the present embodiment, the vertical period is divided into two periods, the scanning period and the non-scanning period, and pixel data is written into each pixel in the scanning period and each pixel performs an intermittent drive for holding the written pixel data in the non-scanning period. Hereinafter, for the sake of convenience, the operation in the scanning period is referred to as a “write operation”, and the operation in the non-scanning period is referred to as a “holding operation”. In the case of a color display by means of three primary colors (R, G, B), the “pixel data” to be written into each pixel is gradation data of each color. In the case of making a color display including a different color (e.g., yellow) in addition to the three primary colors and monochrome luminance data, gradation data of the different color and the luminance data are also included in the pixel data. The display control circuit 3 receives timing control information Dt in accordance with an attribute of an image that is displayed in the pixel array, from an external signal source, to determine respective lengths of the scanning period and the non-scanning period within one vertical period. Herein, the attribute of the image includes drawing rate requirements for a still image, a moving image drawn at the normal refresh rate (60 Hz), a moving image that can be drawn at a rate lower than 60 Hz, a moving image required to be drawn at a rate higher than 60 Hz, and the like. In one embodiment, for example, when a refresh rate (drawing rate) of an image that is displayed in the pixel array is received as the timing control information Dt, the length of the scanning period is determined based on a previously set rule in accordance with the range of the received refresh rate, and the length of the non-scanning period is determined by subtracting the determined length of the scanning period from a length of one vertical period that is set by a reciprocal of the received refresh rate. For example, when the received refresh rate is not higher than 60 Hz, the length of the scanning period is fixed to 1/120 sec (about 8.333 msec), and when the received refresh rate is not lower than 60 Hz, the length of the scanning period is determined to ½ of the length of one vertical period that is set by a reciprocal of the refresh rate. However, when the length of the scanning period is smaller than the minimum value of a length of a scanning period that is set by drain current characteristics at the time of turning-on of the TFT 13 of the pixel and a parasitic capacitance of the pixel electrode 10, the length is determined to be the minimum value. Further, in another example, in the case of receiving an image attribute code indicating an attribute of an image as the timing control information Dt, the respective lengths of the one vertical period, the scanning period, and the non-scanning period, which are previously set in accordance with the received image attribute code, may be read from a predetermined table and then used. Moreover, in place of receiving the timing control information Dt, a below-mentioned timing signal Ct may include timing information for the respective starts of the scanning period and the non-scanning period, and the scanning period and the non-scanning period may be determined based on the timing signal Ct.

At the time of the write and holding operations, the display control circuit 3 receives a data signal Dv indicating an image to be displayed and the timing signal Ct from the external signal source, and respectively generates, as signals for displaying an image in the pixel array, a digital image signal DA and a data-side timing control signal Stc that are given to the source driver 4, a scanning-side timing control signal Gtc that is given to the gate driver 5, and an opposite voltage control signal Sec that is given to the common driver 6, based on the signals Dv, Ct. It is to be noted that part or the whole of the display control circuit 3 is preferably formed within the source driver 4 or the gate driver 5.

The source driver 4 is a circuit which applies a source signal having a predetermined voltage value in predetermined timing to each source line SL at the time of each of the above operations, by control from the display control circuit 3. At the time of the write operation, based on the digital image signal DA and the data-side timing control signal Stc, the source driver 4 generates a pixel data voltage adapted to a voltage level of an opposite voltage Vcom which corresponds to a pixel value for one display line indicated by the digital image signal DA, as source signals Sc1, Sc2, . . . , Scm, Scm+1 (in the case of the first pixel array configuration) in each horizontal period. One scanning period is obtained by repeating one horizontal period the number of times of rows (n times). The pixel data voltage is a voltage corresponding to pixel data, and is a multiple-gradation analog voltage (plurality of mutually separated voltage values). These source signals are then applied to respectively corresponding source lines SL1, SL2, . . . , SLm, SLm+1 (in the case of the first pixel array configuration). Further, at the time of the holding operation, the source driver 4 generates predetermined intermediate voltages as the source signals Sc1, Sc2, . . . , Scm, Scm+1 (in the case of the first pixel array configuration), and applies these source signals to the respectively corresponding source lines SL1, SL2, . . . , SLm, SLm+1 (in the case of the first pixel array configuration) in the non-scanning period.

The gate driver 5 is a circuit which applies a gate signal having a predetermined voltage amplitude in predetermined timing to each gate line GL in the scanning period and the non-scanning period by control from the display control circuit 3. In the scanning period, in order to write pixel data corresponding to the source signals Sc1, Sc2, . . . , Scm, Scm+1 (in the case of the first pixel array configuration) into each pixel based on the scanning-side timing control signal Gtc, the gate driver 5 sequentially selects gate lines GL1, GL2, . . . , GLn one by one in almost every horizontal period and applies a first scanning voltage Vgp to a gate line of the selected row, while applying a second scanning voltage Vgn to a gate line of the unselected row, to sequentially activate pixels in each row. Further, in the non-scanning period, the gate driver 5 applies a non-scanning voltage Vgh to all the gate lines GL1, GL2, . . . , GLn, to deactivate all the pixels in each row. Similarly to the pixel array, the gate driver 5 may be formed on an active matrix substrate.

The common driver 6 applies the opposite voltage Vcom to the opposite electrode 11 via opposite electrode wiring CML. In the present embodiment, the opposite voltage Vcom is kept at a constant voltage through the write and holding operations over a plurality of frames. In the present embodiment, a polarity inversion drive with respect to each frame is performed by inverting a voltage polarity of the source signals Sc1, Sc2, . . . , Scm, Scm+1 (in the case of the first pixel array configuration) on the source line SL side in each vertical period.

In the present invention, one vertical period is divided into the scanning period and the non-scanning period, and the invention is characterized by the voltage polarity of the source signals Sc1, Sc2, . . . , Scm, Scm+1 which are applied to the source lines SL1, SL2, . . . , SLm, SLm+1 at the time of performing the write operation in the scanning period and performing the holding operation in the non-scanning period, and by the value of the intermediate voltage that is applied in the non-scanning period. Hereinafter, details of the write operation and the holding operation in the present embodiment will be described. As for the pixel array, the case of the first pixel array configuration illustrated in FIG. 3 is assumed, and the number of rows n and the number of columns m of the pixel array are respectively even numbers.

FIG. 7 schematically illustrates voltage waveforms applied to the gate lines GL1, GL2, . . . , GLn, the source lines SL1, SL2, . . . , SLm, SLm+1, and the opposite electrode 11, and voltage waveforms of voltage fluctuations ΔV (ΔV1, ΔV2, ΔV3: absolute value) caused by the leak current of the TFT 13 from the time immediately after writing of a pixel voltage V10 that is held in the pixel electrode 10. By transition of the voltage of the gate line GL from the first scanning voltage Vgp (e.g., 8 to 10 V) to the second scanning voltage Vgn (e.g. −8 to −10 V), the pixel voltage V10 transferred from the source line SL to the pixel electrode 10 in the selected row decreases by an amount corresponding to a pull-in voltage ΔVg due to a parasitic capacitance among the gate, the drain, and the channels of the TFT 13. The pull-in voltage ΔVg is generated with respect to every pixel, but the decrease range thereof varies depending on a voltage value of the source signal Sc and variations in characteristics of the TFT 13 of each pixel. Accordingly, in order to compensate an average pull-in voltage ΔVga, a counter electrode voltage Vcom (=ΔV0−ΔVga) as a voltage value obtained by offsetting an amount corresponding to ΔVga from a predetermined fixed potential V0 (ground potential 0V in the present embodiment) is applied to the opposite electrode 11. Further, variations in pull-in voltage ΔVg depending on the voltage value of the source signal Sc are dissolved by correcting the voltage value of the source signal Sc so as to absorb the variations. In FIG. 7, the voltage fluctuations ΔV with respect to the pixel voltage V10 after the decrease just by the pull-in voltage ΔVg is indicated by being classified into three kinds of fluctuations, i.e., a voltage fluctuation ΔV1 of the pixel (pixel P1) in the top row (first row) of a certain column, a voltage fluctuation ΔV2 of the pixel (pixel P2) in an intermediate row (n/second row) of the certain column, and a voltage fluctuation ΔV3 of the pixel (pixel P3) in a final row (n-th row) of the certain column. The case is assumed where any source line SL of the column is the odd-numbered source lines SL1, SLm+1. In the case of even-numbered source lines SL2, SLm, voltage waveforms of vertical periods Tv1, Tv2 are merely changed.

As illustrated in FIG. 7, during a scanning period T1, the first scanning voltage Vgp is sequentially applied to the gate lines GL1, GL2, . . . , GLn one by one almost in each horizontal period, and the second scanning voltage Vgn is applied to the gate lines GL1, GL2, . . . , GLn of the remaining non-selective row. Further, in a non-scanning period T2, the non-scanning voltage Vgh is applied to all the gate lines GL1, GL2, . . . , GLn. Although the second scanning voltage Vgn and the non-scanning voltage Vgh are the same voltage in the present embodiment, the non-scanning voltage Vgh is not necessarily required to be the same voltage as the second scanning voltage Vgn in the non-scanning period T2 as long as the TFT 13 of each pixel is set to a non-conducting state regardless of an intermediate voltage Vsh (Vhp, Vhn) that is applied to each source line SL or the pixel voltage V10 held in the pixel voltage V10. As in the present embodiment, by making the second scanning voltage Vgn equal to the non-scanning voltage Vgh, an influence exerted by the voltage change on the fluctuations in the pixel voltage V10 can be eliminated since there is no change in voltage of each gate line GL at the time of transition from the scanning period T1 to the non-scanning period T2.

As illustrated in FIG. 7, in the successive two vertical periods Tv1, Tv2, in the scanning period T1 of the first vertical period Tv1, the source signals Sc1, Scm+1 of the positive signal voltage are sequentially supplied, as absolute values corresponding to pixel data to be written with respect to each horizontal period, to the odd-numbered source lines SL1, SLm+1 with the fixed potential V0 (=0V) as a reference, while the source signals Sc2, Scm of the negative signal voltage are sequentially supplied, as absolute values corresponding to pixel data to be written with respect to each horizontal period, to the even-numbered source lines SL2, SLm with the fixed potential V0 (=0V) as the reference, and in the non-scanning period T2 of the first vertical period Tv1, the positive intermediate voltage Vhp is commonly supplied to the odd-numbered source lines SL1, SLm+1 with the fixed potential V0 (=0V) as the reference, while the negative intermediate voltage Vhn is commonly supplied to the even-numbered source line SL2, SLm with the fixed potential V0 (=0V) as the reference. In the subsequent second vertical period Tv2, in the scanning period T1 and the non-scanning period T2, polarities of the signal voltage and the intermediate voltage which are applied to the odd-numbered source lines SL1, SLm+1 are inverted from those in the first vertical period Tv1 and become negative, whereas polarities of the signal voltage and the intermediate voltage which are applied to the even-numbered source lines SL2, SLm are inverted from those in the first vertical period Tv1 and become positive. Hereinafter, the polarities of the signal voltage and the intermediate voltage are inverted in each vertical period. As illustrated in FIG. 7, the driving method for the source line SL is characterized in that a voltage having the same polarity is applied to one source line SL throughout one vertical period. It is to be noted that an absolute value of the positive or negative signal voltage that is applied in each horizontal period in the scanning period T1 is set in accordance with pixel data to be written.

As the pixel array, one having the configuration of the first pixel array illustrated in FIG. 3 is used, a voltage having the same polarity is applied to one source line SL throughout the one vertical period, and further, the polarities are inverted between the odd-numbered source lines SL1, SLm+1 and the even-numbered source lines SL2, SLm. As a result, the polarity inversion drive of each pixel becomes a frame inversion drive, and a dot inversion drive is performed in each frame with respect to the pixel array. That is, in the same frame (within the same vertical period), the polarity of the pixel voltage with the potential of the opposite electrode as a reference is inverted between pixels adjacent in the row direction and the column direction, and the pixel voltage is written.

The positive intermediate voltage Vhp is given as an intermediate value (average value) of a maximum value V10a and a minimum value V10b of the positive pixel voltage V10 that is written into each pixel electrode 10 of the pixel connected to a certain source line SLi (i=1 to m+1) in the scanning period T1. When the maximum value and the minimum value of the signal voltage (absolute value) that is applied to the source line SLi are respectively Vs1, Vs0 and the pull-in voltage ΔVg is considered, the intermediate voltage Vhp is given by the following Mathematical Expression 2. One of the maximum value Vs1 and the minimum value Vs0 of the signal voltage (absolute value) corresponds to the maximum gradation of the pixel data, and the other corresponds to the minimum gradation of the pixel data. Herein, ΔVg1 is a pull-in voltage in the case of applying the signal voltage Vs1, ΔVg0 is a pull-in voltage in the case of applying the signal voltage Vs0, and an average value of these two pull-in voltages ΔVg1, ΔVg0 is ΔVgp.

$$\begin{matrix}Vhp = ( V 10 a + V 10 b ) / 2 \\ = ( Vs 1 - Δ Vg 1 + Vs 0 - Δ Vg 0 ) / 2 \\ = ( Vs 1 + Vs 0 ) / 2 - Δ Vgp\end{matrix} \qquad Mathematical Expression 2$$

The negative intermediate voltage Vhn is given as an intermediate value (average value) of the maximum value −V10c and a minimum value −V10b of the negative pixel voltage V10 that is written into each pixel electrode 10 of a pixel connected to a certain source line SLi (i=1 to m+1) in the scanning period T1. When the maximum value and the minimum value of the signal voltage (absolute value) that is applied to the source line SLi are respectively Vs1, Vs0 and the pull-in voltage ΔVg is considered, the intermediate voltage Vhn is given by the following Mathematical Expression 3. Herein, ΔVg3 is a pull-in voltage in the case of applying the signal voltage −Vs1, ΔVg2 is a pull-in voltage in the case of applying the signal voltage −Vs0, and an average value of these two pull-in voltages ΔVg3, ΔVg2 is ΔVgn.

$$\begin{matrix}Vhn = ( - V 10 c - V 10 d ) / 2 \\ = ( - Vs 1 - Δ Vg 3 - Vs 0 - Δ Vg 2 ) / 2 \\ = - ( Vs 1 + Vs 0 ) / 2 - Δ Vgn\end{matrix} \qquad Mathematical Expression 3$$

In Mathematical Expressions 2 and 3, ΔVgp and ΔVgn are calculated using values of ΔVg0, ΔVg1, ΔVg2, ΔVg3 obtained by a simulation or an experiment. Further, the average pull-in voltage ΔVga can be calculated as an average value of ΔVg0, ΔVg1, ΔVg2, ΔVg3. Herein, as described above, when the voltage value of the source signal Sc is corrected so as to absorb variations in pull-in voltage ΔVg caused by a difference in the voltage value, ΔVgp can be made substantially equal to ΔVgn, and in Mathematical Expressions 2 and 3, ΔVga may be used in place of ΔVgp and ΔVgn.

Next, there will be considered the voltage fluctuations ΔV (ΔV1, ΔV2, ΔV3: absolute value) caused by the source-drain leak current of the TFT 13 of the pixel voltage V10 which has been written into the pixel P1, the pixel P2, and the pixel P3.

First, in the pixel P1, since the pixel voltage V10 is updated in the first horizontal period of the scanning period T1, the voltage fluctuation ΔV1 successively increases throughout the remaining scanning period T1 and non-scanning period T2. In the scanning period T1 of the vertical period Tv1, the positive signal voltage (Vs0 to Vs1) is applied to the odd-numbered source lines SL1, SLm+1, and the pixel voltage V10 of the pixel P1 becomes a voltage value between (Vs0−ΔVg0) and (Vs1−ΔVg1). Hence the maximum value (Vds1) of the bias voltage Vds that is applied between the source and the drain of the TFT 13 of the pixel P1 throughout the scanning period T1 is |Vs1−Vs0+ΔVg0|. Therefore in the worst case, a voltage fluctuation is successively generated by the leak current at the time of the maximum bias voltage. Subsequently, in the non-scanning period T2, the maximum value (Vds2) of the bias voltage Vds that is applied between the source and the drain of the TFT 13 of the pixel P1 is |Vhp−Vs0+ΔVg0|. In the case of VS1=5 V and VS0=0 V, Vds1=5+ΔVg0 and Vds2=2.5 V+(ΔVg0−ΔVgp) are obtained, and Vds2 is decreased to about ½ of Vds1. Since the gate bias Vgs of the TFT 13 in the non-conducting state is a difference between the second scanning voltage Vgn that is applied to the gate and a lower voltage of either the source or the drain, (Vgn−Vs0) or (Vgn−Vs0+ΔVg0) becomes a negative gate bias value at the time of the bias voltage Vds being the maximum, and there is not a significant difference throughout the scanning period T1 and the non-scanning period T2. Therefore, the leak current of the TFT 13 at the time of the non-scanning period T2 decreases in accordance with the decrease in maximum value of the bias voltage Vds and the degree of the decrease in the leak current is greater than that in the maximum value of the bias voltage Vds, and hence the increase in voltage fluctuation ΔV1 is alleviated in the non-scanning period T2.

In the scanning period T1 of the next vertical period Tv2, the negative signal voltage (−Vs1 to −Vs0) is applied to the odd-numbered source lines SL1, SLm+1, and the pixel voltage V10 of the pixel P1 becomes a voltage value between (−Vs1−ΔVg3) and (−Vs0−ΔVg2). Hence the maximum value (Vds1) of the bias voltage Vds that is applied between the source and the drain of the TFT 13 of the pixel P1 throughout the scanning period T1 is |Vs1−Vs0+ΔVg3|. Therefore, in the worst case, a voltage fluctuation is successively generated by the leak current at the time of the maximum bias voltage. Subsequently, in the non-scanning period T2, the maximum value (Vds2) of the bias voltage Vds that is applied between the source and the drain of the TFT 13 of the pixel P1 is |Vhn+Vs1+ΔVg3|. In the case of VS1=5 V and VS0=0 V, Vds1=5+ΔVg3 and Vds2=2.5 V+(ΔVg3−ΔVgn) are obtained, and Vds2 is decreased to about ½ of Vds1. Since the gate bias Vgs of the TFT 13 in the non-conducting state is a difference between the second scanning voltage Vgn that is applied to the gate and a lower voltage of either the source or the drain, (Vgn+Vs1) or (Vgn+Vs1+ΔVg3) becomes a negative gate bias value at the time of the bias voltage Vds being the maximum, and there is not a significant difference throughout the scanning period T1 and the non-scanning period T2. Therefore, the leak current of the TFT 13 at the time of the non-scanning period T2 decreases in accordance with the decrease in maximum value of the bias voltage Vds and the degree of the decrease in the leak current is greater than that in the maximum value of the bias voltage Vds, and hence the increase in voltage fluctuation ΔV1 is alleviated in the non-scanning period T2. However, since the absolute value of the negative gate bias value in the vertical period Tv2 is smaller than that in the vertical period Tv1, the leak current of the TFT 13 throughout the scanning period T1 and the non-scanning period T2 is smaller than that in the vertical period Tv1, whereby the increase in voltage fluctuation ΔV1 is suppressed.

Next, in the pixel P2, since the pixel voltage V10 is updated in a horizontal period at the time point being a half of the scanning period T1, the voltage fluctuation ΔV2 successively increases throughout the scanning period T1 and the non-scanning period T2 after updating. In the scanning period T1 before updating of the vertical period Tv1, the positive signal voltage (Vs0 to Vs1) is applied to the odd-numbered source lines SL1, SLm+1, and the pixel voltage V10 of the pixel P1 becomes a voltage value between (−Vs1−ΔVg3) and (−Vs0−ΔVg2) which has been written in the last vertical period. Hence the maximum value (Vds1) of the bias voltage Vds that is applied between the source and the drain of the TFT 13 of the pixel P2 in the scanning period T1 before updating is |2Vs1+ΔVg3|. In the case of VS1=5 V and VS0=0 V, Vds1=10+ΔVg3 is obtained, and it becomes about twice as large as the maximum value (Vds1=5+ΔVg0) of the bias voltage Vds of the pixel P1. However, since the gate bias Vgs of the TFT 13 in the non-conducting state is a difference between the second scanning voltage Vgn that is applied to the gate and a lower voltage of either the source or the drain, (Vgn−Vs1+ΔVg3) is obtained, and in the case of VS1=5 V and VS0=0 V, it is smaller than the negative gate bias value in the scanning period T1 of the pixel P1 by about 5 V in the absolute value. Therefore, in the worst case, a voltage fluctuation is successively generated by the leak current at the time of the maximum bias voltage. At the time of updating of the pixel P2, the voltage fluctuation is once reset to 0 V. Subsequently, in the scanning period T1 and the non-scanning period T2 after updating of the pixel P2, in the worst case, the source-drain bias voltage Vds and the negative gate bias similar to those of the pixel P1 are obtained. Therefore, although the start point of the voltage fluctuations ΔV is different, a similar change is made to the pixel P1.

Also in the subsequent vertical period Tv2, similarly to the vertical period Tv1, the pixel voltage V10 of the pixel P2 is updated in a horizontal period at the time point being a half of the scanning period T1. In the scanning period T1 before updating of the vertical period Tv2, the negative signal voltages (−Vs1 to −Vs0) is applied to the odd-numbered source lines SL1, SLm+1, and the pixel voltage V10 of the pixel P1 becomes a voltage value between (Vs0−ΔVg0) and (Vs1−ΔVg1) which has been written in the last vertical period. Hence the maximum value (Vds1) of the bias voltage Vds that is applied between the source and the drain of the TFT 13 of the pixel P2 in the scanning period T1 before updating is |2Vs1−ΔVg1|. In the case of VS1=5 V and VS0=0 V, Vds1=10−ΔVg1 is obtained, and Vds1 becomes about twice as large as the maximum value (Vds1=5+ΔVg3) of the bias voltage Vds of the pixel P1. However, since the gate bias Vgs of the TFT 13 in the non-conducting state is a difference between the second scanning voltage Vgn that is applied to the gate and a lower voltage of either the source or the drain, (Vgn+Vs1) is obtained, and in the case of VS1=5 V and VS0=0 V, it becomes substantially the same value as the negative gate bias value in the scanning period T1 of the pixel P1. Therefore in the worst case, a voltage fluctuation is successively generated by the leak current at the time of the maximum bias voltage. At the time of updating of the pixel P2, the voltage fluctuation ΔV2 is once reset to 0 V. Subsequently, in the scanning period T1 and the non-scanning period T2 after updating of the pixel P2, in the worst case, the source-drain bias voltage Vds and the negative gate bias similar to those of the pixel P1 are obtained. Therefore, although the start point of the voltage fluctuation ΔV2 becomes later than that of the voltage fluctuation ΔV1, a similar change is made to the pixel P1.

Next, in the pixel P3, since the pixel voltage V10 is updated in the final horizontal period of the scanning period T1, the voltage fluctuation ΔV3 increases in the scanning period T1 successively from the non-scanning period T2 of the last vertical period, and is once reset to 0 V at the time of updating in the final horizontal period of the scanning period T1, and the voltage fluctuation ΔV3 successively increases throughout the non-scanning period T2 after updating and the scanning period T1 of the subsequent vertical period. In the scanning period T1 of the vertical period Tv1, the positive signal voltages (Vs0 to Vs1) is applied to the odd-numbered source lines SL1, SLm+1, and the pixel voltage V10 of the pixel P1 becomes a voltage value between (−Vs1−ΔVg3) and (−Vs0−ΔVg2) which has been written in the last vertical period. Hence the maximum value (Vds1) of the bias voltage Vds that is applied between the source and the drain of the TFT 13 of the pixel P2 in the scanning period T1 is |2Vs1+ΔVg3|. In the case of VS1=5 V and VS0=0 V, Vds1=10+ΔVg3 is obtained, and Vds1 becomes about twice as large as the maximum value (Vds1=5+ΔVg0) of the bias voltage Vds of the pixel P1. However, since the gate bias Vgs of the TFT 13 in the non-conducting state is a difference between the second scanning voltage Vgn that is applied to the gate and a lower voltage of either the source or the drain, (Vgn−Vs1+ΔVg3) is obtained, and in the case of VS1=5 V and VS0=0 V, it becomes smaller than the negative gate bias value in the scanning period T1 of the pixel P1 by about 5 V in the absolute value. Therefore in the worst case, a voltage fluctuation is successively generated by the leak current at the time of the maximum bias voltage. At the time of updating of the pixel P3, the voltage fluctuation is once reset to 0 V. Subsequently, in the non-scanning period T2, in the worst case, the source-drain bias voltage Vds and the negative gate bias similar to those of the pixels P1 and P2 are obtained, and hence a similar change is made to the pixels P1 and P2.

Also in the subsequent vertical period Tv2, similarly to the vertical period Tv1, the pixel voltage V10 of the pixel P3 is updated in the final horizontal period of the scanning period T1. In the scanning period T1 of the vertical period Tv2, the negative signal voltages (−Vs1 to −Vs0) is applied to the odd-numbered source lines SL1, SLm+1, and the pixel voltage V10 of the pixel P3 becomes a voltage value between (Vs0−ΔVg0) and (Vs1−ΔVg1) which has been written in the last vertical period. Hence the maximum value (Vds1) of the bias voltage Vds that is applied between the source and the drain of the TFT 13 of the pixel P3 in the scanning period T1 is |2Vs1−ΔVg1|. In the case of VS1=5 V and VS0=0 V, Vds1=10−ΔVg1 is obtained, and Vds1 becomes about twice as large as the maximum value (Vds1=5+ΔVg3) of the bias voltage Vds of the pixel P1. However, since the gate bias Vgs of the TFT 13 in the non-conducting state is a difference between the second scanning voltage Vgn that is applied to the gate and a lower voltage of either the source or the drain, (Vgn+Vs1) is obtained, and in the case of VS1=5 V and VS0=0 V, it becomes substantially the same value as the negative gate bias value in the scanning period T1 of the pixel P1. Therefore, in the worst case, a voltage fluctuation is successively generated by the leak current at the time of the maximum bias voltage. At the time of updating of the pixel P3, the voltage fluctuation ΔV2 is once reset to 0 V. Subsequently, in the non-scanning period T2, in the worst case, the source-drain bias voltage Vds and the negative gate bias similar to those of the above pixels P1 and P2 are obtained, and hence a similar change is made to the pixels P1 and P2.

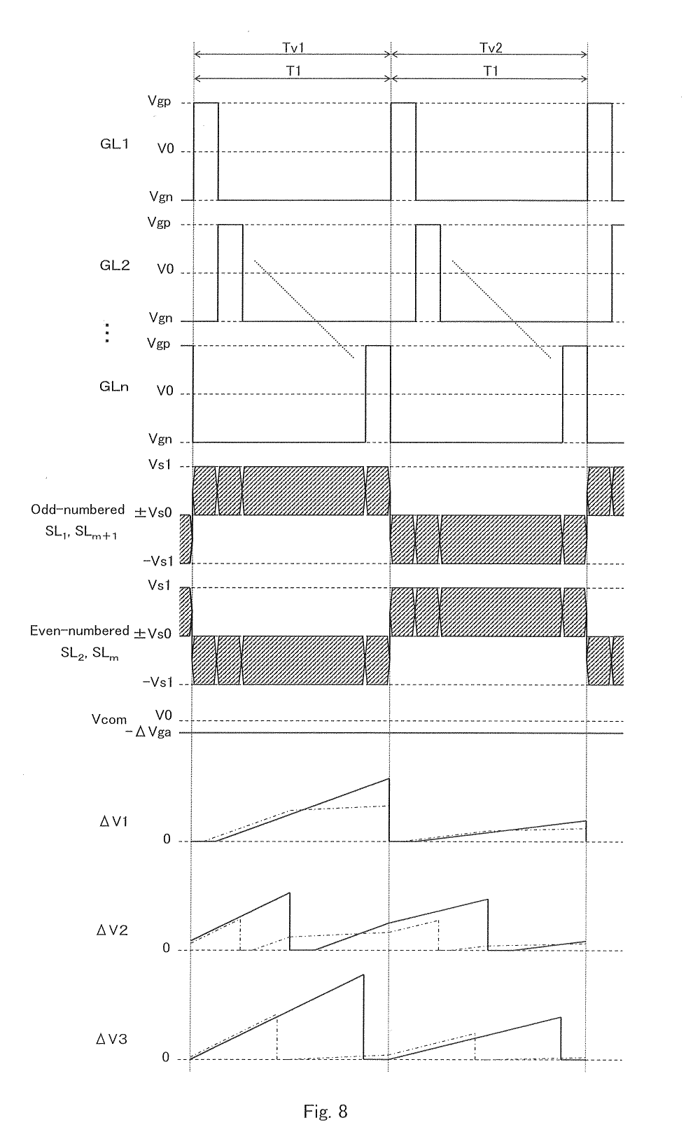

In the scanning period T1 before updating of the pixel data of the pixels P2 and P3, an increase in leak current due to an increase in source-drain bias voltage Vds and a decrease in leak current due to a decrease in negative gate bias are simultaneously generated, but in FIG. 7, a case has been assumed in which an influence exerted by the former case is greater. Therefore, in this assumption, as illustrated in FIG. 7, when the voltage fluctuations ΔV1, ΔV2, ΔV3 of the pixels P1, P2, P3 are compared, the voltage fluctuation ΔV3 in the scanning period T1 of the vertical period Tv1 of the pixel P3 is the largest in the worst case. However, in the pixel P3, the maximum value (Vds1) of the bias voltage Vds that is applied between the source and the drain of the TFT 13 in each of the vertical periods Tv1, Tv2 is significantly reduced in the non-scanning period T2 to ¼ of that in the scanning period T1. Hence, providing the non-scanning period T2 within each of the vertical periods Tv1, Tv2 can suppress the voltage fluctuation ΔV3. This applies to the other pixels P1 and P2. For reference, FIG. 8 schematically illustrates voltage waveforms of the voltage fluctuations ΔV1, ΔV2, ΔV3 of the pixels P1, P2, P3 in the case of not providing the non-scanning period T2 (Comparative Example 1). Further, for facilitating the comparison, FIG. 8 illustrates voltage waveforms of the voltage fluctuations ΔV1, ΔV2, ΔV3 of FIG. 7, by alternate long and short dash lines. Any voltage fluctuation ΔV increases by an amount corresponding to the increased length of the scanning period T1, resulting in higher flicker visibility.

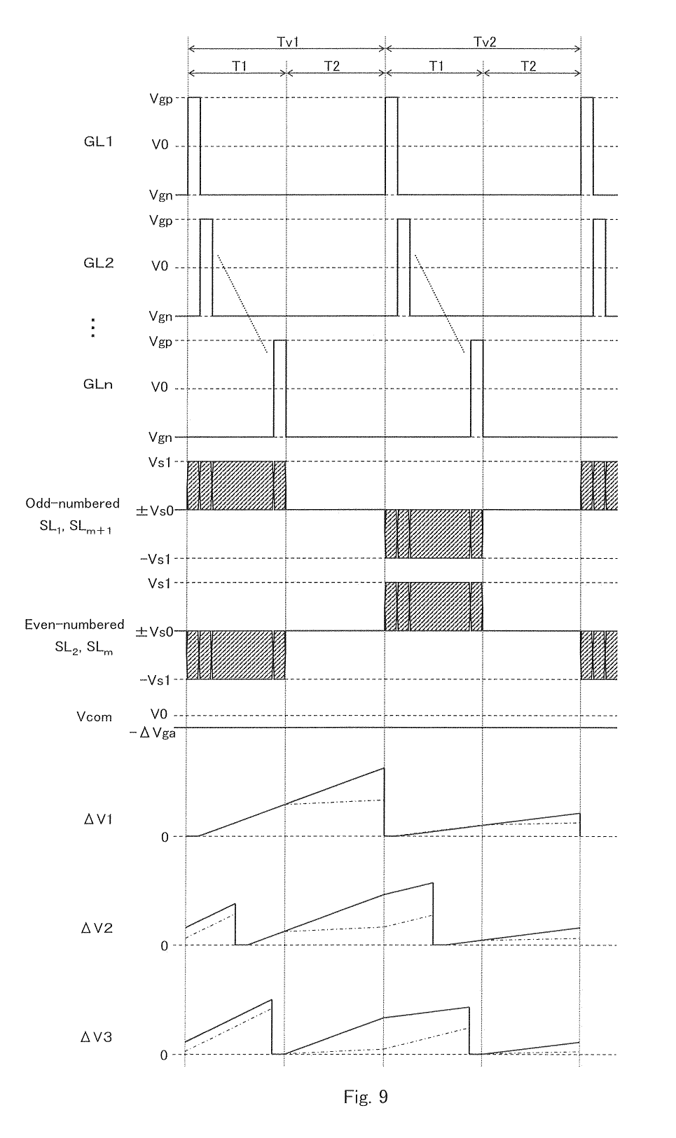

Further for reference, FIG. 9 schematically illustrates voltage waveforms of the voltage fluctuations ΔV (ΔV1, ΔV2, ΔV3: absolute value) among the pixels P1, P2, P3 in the case of applying the same voltage as the opposite voltage Vcom (=V0−ΔVga) in place of the intermediate voltages Vhp, Vhn as the voltage that is applied to each source line SL in the non-scanning period T2 (Comparative Example 2). Further, for facilitating the comparison, FIG. 9 illustrates voltage waveforms of the voltage fluctuations ΔV1, ΔV2, ΔV3 of FIG. 7, by alternate long and short dash lines. In this case, the maximum value (Vds1) of the bias voltage Vds that is applied between the source and the drain of the TFT 13 of each of the pixels P1, P2, P3 in the non-scanning period T2 is substantially the same as the maximum value (Vds1) of the bias voltage Vds that is applied between the source and the drain of the TFT 13 of the pixel P1 in the scanning period T1 in the worst case. Therefore, although the voltage fluctuation ΔV3 in the pixel P3 is more slightly suppressed than in Comparative Example 1 illustrated in FIG. 8, the voltage fluctuation ΔV1 in the pixel P1 is the same as that in the case of Comparative Example 1. Hence, also in Comparative Example 2, any voltage fluctuation ΔV increases by an amount corresponding to the increased voltage fluctuation in the non-scanning period T2, resulting in higher flicker visibility than that in the present embodiment illustrated in FIG. 7.

From the above descriptions, in the display device 1 of the present embodiment, as illustrated in FIG. 7, one vertical period is divided into the scanning period T1 and the non-scanning period T2, and a voltage polarity of the source signals Sc1, Sc2, . . . , Scm+1 which are applied to the source lines SL1, SL2, . . . , SLm+1 at the time of performing the write operation in the scanning period and the holding operation in the non-scanning period is kept fixed with respect to each source line SL throughout one vertical period. Further, the intermediate voltage that is applied in the non-scanning period T2 is set to the voltage values Vhp, Vhn obtained by Mathematical Expressions 2 and 3, whereby it is possible to suppress the voltage fluctuation ΔV that is generated throughout one vertical period in the pixel electrode 10 of each pixel, so as to effectively suppress flicker.

Further, in the present embodiment, since one having the configuration of the first pixel array illustrated in FIG. 3 is used as the pixel array, the foregoing dot inversion drive is realized. Factors of the flicker include, other than the foregoing voltage fluctuation of the pixel voltage caused by the leak current of the TFT, the asymmetry in which the voltage change that is made in updating the pixel voltage differs between the time of polarity inversion from the negative polarity to the positive polarity and the time of polarity inversion from the positive polarity to the negative polarity at the time of the frame inversion drive of each pixel. In the case of the dot inversion drive, there is such an advantage that the difference in voltage change due to this asymmetry is uniformly dispersed to the whole of the pixel array, to make the flicker difficult to view.

Further, in the present embodiment, as illustrated in FIG. 2, since no auxiliary capacitive element is provided in each pixel, a load capacity of the pixel electrode 10 seen from a current driving ability of the TFT 13 is alleviated, thereby allowing reduction in one horizontal period even in the case of using a TFT with a low current driving ability such as an amorphous silicon TFT, and the scanning period T1 can be made not more than ½ of one vertical period (about 16.67 msec) determined with the normal refresh rate of 60 Hz. Hence it is preferable to further reduce the scanning period T1 in accordance with the current driving ability of the TFT that is used and the parasitic capacitance of the pixel electrode 10. In particular, by an amount corresponding to reduction in parasitic capacitance of the pixel electrode 10, the voltage fluctuation ΔV per unit time in the pixel electrode 10 with respect to the leak current of the same T13 increases, and hence a ratio of the scanning period T1 within one vertical period is preferably made small. For example, when assuming that an electrical capacitance of the auxiliary capacitive element is the same as an electrical capacitance of the unit liquid crystal display element 12, the current driving ability of the TFT 13 is relatively doubled due to the absence of the auxiliary capacitive element, and hence the scanning period T1 is made further shorter than ½ of the conventional one vertical period (e.g., not more than ¼ thereof). As a result, it is possible to reduce the voltage fluctuation ΔV that is generated throughout one vertical period than that of the pixel provided with the auxiliary capacitive element, and further realize improvement in aperture ratio as described above.

Moreover, power consumption for driving the liquid crystal display device is almost dominated by power consumption for driving a source line by a source driver as described in the section of Background Art. As is apparently seen in FIG. 7, this is because each of gate lines GL is pulse-driven only once within one vertical period whereas each of the source lines SL is driven the same number of times as the number of gate lines GL within one vertical period. In the first pixel array configuration, the need arises in each source line SL for changing the signal voltage between the maximum value and the minimum value in each horizontal period in the case of writing a monochrome vertically striped pattern or a monochrome horizontally striped pattern, and this becomes the worst case of power consumption associated with the drive of the source line, as in a relational expression shown in Mathematical Expression 1. In the second pixel array configuration illustrated in FIG. 4, the need arises in each source line SL for changing the signal voltage between the maximum value and the minimum value in each horizontal period in the case of writing a monochrome checkered pattern or a monochrome horizontally striped pattern, and this becomes the worst case of power consumption associated with the drive of the source line.

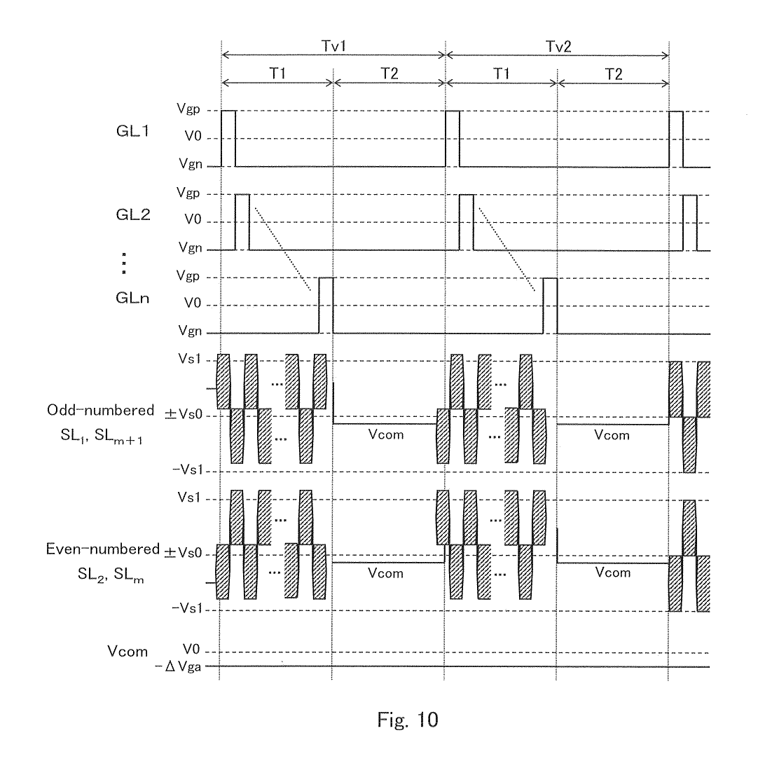

In the example illustrated in FIG. 7, although the non-scanning period T2 is present in one vertical period (refresh interval), the number of drives of each source line SL does not change due to the presence or absence of the non-scanning period T2. Hence, providing the non-scanning period T2 in the same vertical period and reducing the scanning period T1 do not lead to an increase in power consumption for driving the source line. Herein, the drive voltage V of the source driver shown in Mathematical Expression 1 is a voltage amplitude (Vs1−VS0) that is applied to each source line SL in one scanning period T1 in the example illustrated in FIG. 7. As opposed to this, when a dot inversion drive similar to that in the first pixel array configuration is to be realized by use of the second pixel array configuration illustrated in FIG. 4, the need arises for inverting a polarity of a signal voltage that is applied to the source line SL in each horizontal period as illustrated in FIG. 10. Consequently, the drive voltage V becomes 2Vs1 and becomes twice as large as that in the present embodiment illustrated in FIG. 7 in the case of setting Vs0=0 V, while the power consumption for driving the source line increases to four times as large. Further, the voltage that is applied to each source line SL in the non-scanning period T2 also becomes the same voltage as the opposite voltage Vcom that is applied to the opposite electrode 11, instead of the intermediate voltages Vhp, Vhn, and the effect of suppressing the voltage fluctuation ΔV of the pixel voltage V10 in the non-scanning period T2 deteriorates similarly to Comparative Example 2.

In the second pixel array configuration, in order to realize the dot inversion drive while suppressing an increase in power consumption, a voltage amplitude of the signal voltage that is applied to the source line SL may be suppressed to (Vs1−Vs0) similarly to the case of the present embodiment. Thereat, as the countermeasure, there is considered a case where the opposite voltage Vcom that is applied to the opposite electrode 11 is not set to a fixed voltage, but an “opposite AC drive” is used in which driving is performed with the same voltage amplitude as that of the signal voltage that is applied to the source line SL in each horizontal period. However, in the case of this opposite AC drive, in the pixel provided with the auxiliary capacitive element, the auxiliary capacitive line connected to one end of the auxiliary capacitive element is required to be driven in the same manner as the opposite electrode, and since the drive period thereof is the same as the drive period of the source line SL, power consumption required for driving the opposite electrode and the auxiliary capacitive line cannot be ignored. As a result, achievement of lower power consumption of the display device is inhibited. In the present embodiment, even when the opposite voltage Vcom is set to a fixed voltage throughout a plurality of vertical periods, the polarities of the signal voltage and the intermediate voltage that are applied to one source line throughout one vertical period are unified to either the positive or negative polarity. Therefore, it is possible to suppress an amplitude of a voltage that is applied to the source line, so as to achieve the foregoing low power consumption, while avoiding the problem associated with the “opposite AC drive”.

Further, in the present embodiment, since the respective lengths of the one vertical period, the scanning period, and the non-scanning period are appropriately set in accordance with an attribute of an image displayed in the pixel array, it is possible to achieve low consumption power while keeping high display quality. Specifically, the length of the one vertical period is not fixed to 1/60 sec (about 16.67 msec) that is set by a reciprocal of the normal refresh rate of 60 Hz, but one vertical period can be set longer with respect to a still image, a moving image with a slow motion, and the like based on the timing control information Dt, so as to achieve low power consumption. The important point in this case is that, when setting one vertical period to be longer, the scanning period T1 is not made longer, but the non-scanning period T2 during which the leak current of the TFT 13 is suppressed is made longer, thereby allowing suppression of power consumption associated with the drive of the source line while keeping the display quality, so as to achieve lower consumption power. This is different from the conventional low frequency intermittent drive in that, with the source line SL in the non-scanning period T2 being driven by the intermediate voltages Vhp, Vhn, it is possible to sufficiently suppress the voltage fluctuation of the pixel voltage V10 due to the leak current of the TFT 13 even if the non-scanning period T2 is made longer. Moreover, with respect to a moving image with a fast motion or a moving image requiring high-speed drawing (e.g., 3D moving image), the length of one vertical period can be set short based on the timing control information Dt, so as to support high-speed drawing.

As described above, by combining the driving method illustrated in FIG. 7 with the first pixel array configuration illustrated in FIG. 3, there is realized a liquid crystal display device with a simple configuration, which is capable of displaying a full-color still image with low power consumption and low flicker visibility, namely, high display quality. Further, since an auxiliary capacitive element is not provided in each pixel, aperture ratio is improved, and further, display quality is improved. Although the present embodiment has described, as an example, the case where the auxiliary capacitive element is not provided in each pixel, the effect of combining the driving method illustrated in FIG. 7 with the first pixel array configuration illustrated in FIG. 3 is sufficiently achieved even in the case where the auxiliary capacitive element is provided in each pixel.

Next, there will be described another embodiment in the case where the driving method illustrated in FIG. 7 is applied to the display device of the pixel array with the second pixel array configuration illustrated in FIG. 4. Even in the case of driving the gate lines GL1, GL2, . . . , GLn and the source lines SL1, SL2, . . . , SLm of the pixel array with the second pixel array configuration illustrated in FIG. 4 by the driving method illustrated in FIG. 7, the voltage fluctuation of the pixel voltage V10 similar to that in the first pixel array configuration can be suppressed. Except for that the drive of the source line SLm+1 is not necessary due to the absence of the source line SLm+1, the gate line GL, the source line SL, and the opposite electrode 11 can be driven by the driving method illustrated in FIG. 7, and in comparison of the worst cases, the voltage fluctuations ΔV1, ΔV2, ΔV3 of the pixel voltage V10 of the pixels P1, P2, P3 are the same as those in the first pixel array configuration. Therefore, the power consumption associated with the drive of the source line SL is substantially the same although an amount corresponding to one source line SLm+1 is reduced. However, in the second pixel array configuration, the drive of the pixel array is not the dot inversion drive, but the column inversion drive. That is, in the same frame (within the same vertical period), the polarity of the pixel voltage with the potential of the opposite electrode as a reference is not inverted between pixels adjacent in the column direction, but is inverted between pixels adjacent in the row direction, and the pixel voltage is written. Accordingly, also in the case of combining the driving method illustrated in FIG. 7 with the second pixel array configuration illustrated in FIG. 4, the voltage fluctuation suppressing effect of the pixel voltage V10 associated with the leak current of the TFT 13 and low power consumption similar to those in the first pixel array configuration can be achieved. Consequently, the display quality due to reduction in flicker visibility is improved. However, since the drive is not the dot inversion drive as described above, it is disadvantageous for reduction in flicker visibility.

### Another Embodiment

Another embodiment will be described below.

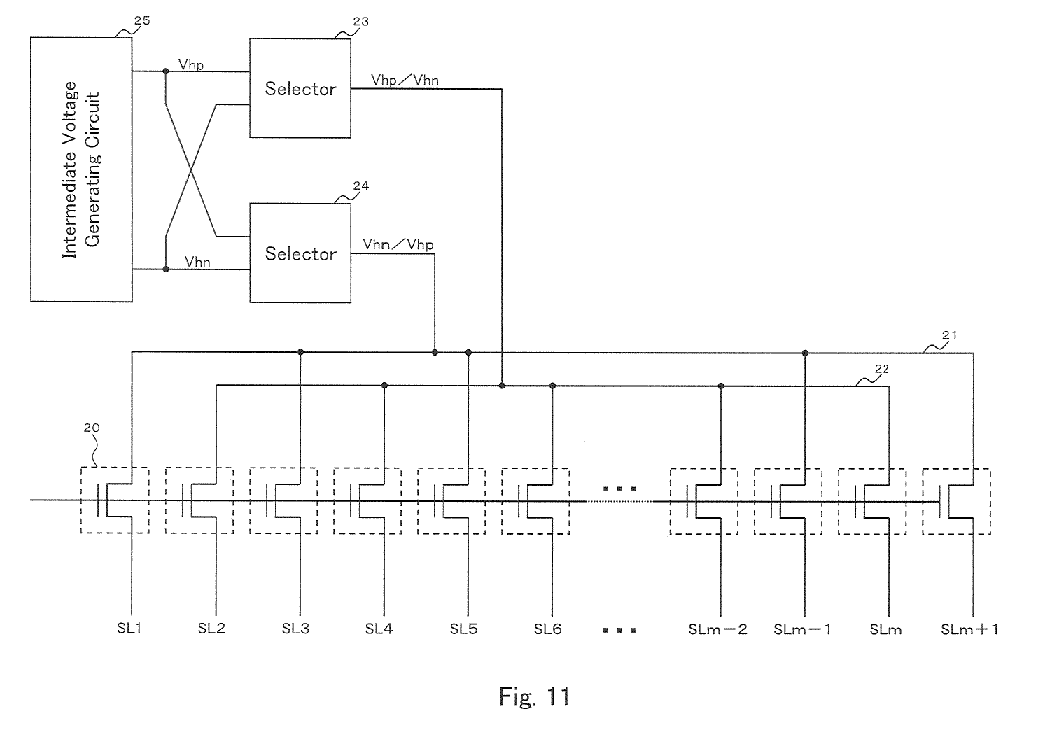

(1) Although the above embodiment has described the case where the source driver 4 applies the intermediate voltages Vhp, Vhn to each source line SL in the non-scanning period T2, the source driver 4 may be specialized for application of the source signals Sc1, Sc2, . . . , Scm, Scm+1 (in the case of the first pixel array configuration) in the scanning period T1, and an intermediate voltage driving circuit for applying the intermediate voltages Vhp, Vhn to each source line SL may be additionally provided, thereby forming a configuration in which application of the intermediate voltages Vhp, Vhn in the non-scanning period T2 is performed by the intermediate voltage driving circuit. In this case, combination of the source driver 4 and the intermediate voltage driving circuit corresponds to the data signal line driving circuit. The intermediate voltage driving circuit is a simple circuit which is connected to each source line SL in the non-scanning period T2, classifies each source line SL into two kinds, i.e., an odd-numbered source line and an even-numbered source line, and then applies the two kinds of voltages, i.e., the intermediate voltage Vhp and the intermediate voltage Vhn, to the one source line and the other source line, respectively. As illustrated in FIG. 11, the intermediate voltage driving circuit can be realized as an example by: a transistor element 20 provided to each source line one by one; selectors 23, 24 that select either the intermediate voltage Vhp or Vhn and drives a first common source line 21 connected to the odd-numbered source line SL via the transistor element 20 or a second common source line 22 connected to the even-numbered source line SL via the transistor element 20; and an intermediate voltage generating circuit 25 that generates the intermediate voltages Vhp, Vhn. The transistor element 20 is controlled so as to be set to a conducting state in the non-scanning period T2 and set to a non-conducting state in the scanning period T1. Further, the intermediate voltage Vhn is applied to the second common source line 22 when the intermediate voltage Vhp is applied to the first common source line 21, and on the contrary, the intermediate voltage Vhp is applied to the second common source line 22 when the intermediate voltage Vhn is applied to the first common source line 21. The source driver 4 and the intermediate voltage driving circuit can respectively be arranged on both sides in the column direction of the liquid crystal panel 2 with the panel interposed therebetween.

For example, in the liquid crystal panel for color display, when respective pixels of RGB are arranged adjacently to each other in the row direction, an arrangement interval between the pixels in the row direction becomes narrow, and a wiring pitch of the source lines SL also becomes narrow. In such a case, the RGB source line may be driven in a time-division manner, but when application of the intermediate voltages Vhp, Vhn to each source line SL in the non-scanning period T2 in the above embodiment is performed in a time-division manner, the source line SL is set to a floating state during ⅔ of the non-scanning period T2. Particularly, when the non-scanning period T2 is made longer and the low frequency intermittent drive is then performed, the source line SL in the floating state may fluctuate in potential, which is not preferable. Accordingly, when the intermediate voltage driving circuit is provided, even in the case where the source line SL is driven in a time-division manner in the scanning period T1, it is constantly drivable in the non-scanning period T2, and it is thus possible to avoid the source line SL to be set to the floating state.

(2) In the above embodiment, the case has been described where, as for application of the intermediate voltages Vhp, Vhn to each source line SL in the non-scanning period T2, the source lines SL are classified into two groups, i.e., the even-numbered source line and the odd-numbered source line, and the same intermediate voltage Vhp is commonly applied to the source lines SL of the one group while the same intermediate voltage Vhn is commonly applied to the source lines SL of the other group. With such a configuration, the intermediate voltage application system can be simplified. However, in place of the application of the common intermediate voltages Vhp, Vhn (common intermediate voltages) as thus described, such application may be performed that the maximum value and the minimum value of the pixel voltage V10, which are actually held in the pixel electrode 10 after being written into the pixels the number of which is equal to the number of rows n connected to the corresponding source lines SL in the last scanning period T1, and reduced by an amount corresponding to the foregoing pull-in voltage ΔVg, are calculated from the maximum value and the minimum value of the signal voltage actually applied to the source lines in the scanning period T1, and an intermediate voltage (individual intermediate voltage) for each source line is obtained as an average value of the maximum value and the minimum value of the actually held pixel voltage V10, so as to be applied to each corresponding source line SL. Further, the individual intermediate voltage may be derived as an average value or a center value of the actually held pixel voltages V10 the number of which is equal to the number of rows n instead of being obtained as the average value of the maximum value and the minimum value of the actually held pixel voltage V10.

(3) In the above embodiment, as illustrated in FIG. 7, the case has been described where, in the scanning period T1, the gate lines GL1, GL2, . . . , GLn are applied with the first scanning voltage Vgp sequentially one by one in the order of arrangement in almost each horizontal period, and then selected. The maximum value (Vds1) of the bias voltage Vds that is applied between the source and the drain of the TFT 13 of each pixel in the scanning period T1 varies before and after updating. Since the maximum value (Vds1) is larger before updating, the voltage fluctuation ΔV of the pixel voltage V10 is larger in a pixel updated later in the scanning period T1. Thereat, in order to alleviate the dependency of the voltage fluctuation ΔV on the order of rows, the order in which the gate line GL is driven may be preferably changed for each lapse of one vertical period. For example, in each vertical period, the order of rows of gate lines GL driven in the top horizontal period of each scanning period T1 is added or subtracted by units of one row or a plurality of rows.

(4) In the above embodiment, in order to compensate the pull-in voltage ΔVg that is generated in the pixel electrode 10 of each pixel, the opposite electrode 11 has been applied with the counter electrode Vcom (=ΔV0−ΔVga) obtained by offsetting an amount corresponding to the average pull-in voltage ΔVga from the predetermined fixed potential V0 (ground potential 0V in the present embodiment). However, for compensation of the pull-in voltage ΔVg, other than the method of offsetting the opposite electrode Vcom, a voltage obtained by adding the pull-in voltage ΔVg to the signal voltage that is applied to each source line SL in each scanning period T1 may be applied. Further, in the case of the pixel provided with the auxiliary capacitive element, one end of the auxiliary capacitive element may be connected to the pixel electrode 10, the other end thereof may be connected to the auxiliary capacitive line extending in the row direction in each row, the auxiliary capacitive line may be driven in a reversed phase to the selected gate line GL in the selected row, and a projecting voltage in the opposite direction to the pull-in voltage ΔVg may be added to the pixel voltage V10 of the pixel electrode 10 via the auxiliary capacitive element, to offset the pull-in voltage ΔVg. In any compensation method, the deriving method for the intermediate voltage that is applied to each source line SL in the non-scanning period T2 is the same. That is, the methods are the same in that the intermediate voltage is derived as the average value of the maximum value and the minimum value (which may be the actually held maximum value and minimum value) of the pixel voltage V10 that can be held in the pixel electrode 10 of the pixel connected to the same source line SL in one non-scanning period T2. However, it should be noted that the intermediate voltage is not the average value of the maximum value and the minimum value of a signal voltage applied to a certain source line SL in the scanning period T1. (5) Although the use of the n-channel type polysilicon TFT or the amorphous silicon TFT as the TFT 13 in each pixel has been assumed in the above embodiment, it is also possible to form a configuration using a reverse-conducting p-channel polysilicon TFT. In the display device having the configuration using the p-channel TFT, adjustment such as reversing the polarities of the first scanning voltage Vgp and the second scanning voltage Vgn which are applied to the respective gate lines GL is required, but the basics of the driving method for the source line SL is the same as those in the above embodiment, and a similar effect can be obtained.

(6) Although concrete numerical values have been clearly specified as the voltages that are applied to the gate line GL, the source line SL, and the opposite electrode 11, these voltage values are appropriately changeable in accordance with characteristics (transmittance characteristics, electrical capacitance, threshold voltage, and the like) of the unit liquid crystal display element 12 and the TFT 13 which are used.

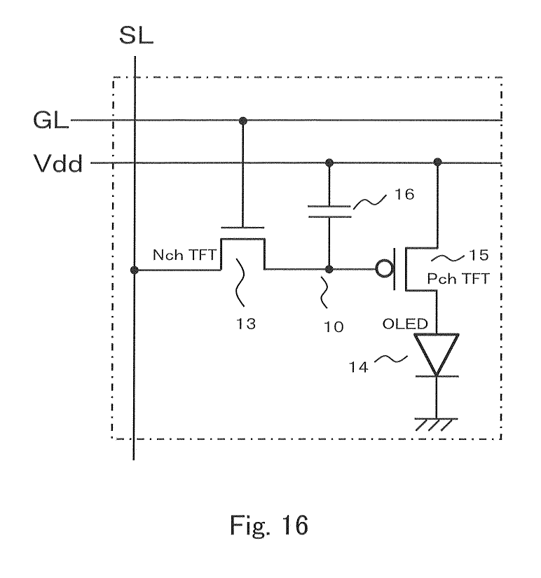

(7) Although the description has been made in the above embodiment by taking as an example the active matrix liquid crystal display device which is configured such that each pixel is provided with the unit liquid crystal display element 12 as illustrated in the equivalent circuit of FIG. 2, the active matrix display device is not limited to the liquid crystal display device. For example, as illustrated in an equivalent circuit of FIG. 16, the data signal line driving circuit and method according to the present invention is also applicable to an organic EL display device with each pixel including an OLED (Organic LED) element 14, the TFT 13, a TFT 15 having opposite conductivity to the TFT 13, and an auxiliary capacitive element 16. Herein, a gate (control terminal) of the TFT 13 is connected to the gate line GL, a first terminal (drain) thereof is connected to the pixel electrode 10, and a second terminal (source) thereof is connected to the source line SL. Further, a gate (control terminal) of the TFT 15 is connected to the pixel electrode 10, a first terminal (drain) thereof is connected to an anode of the OLED element 14, and a second terminal (source) thereof is connected to a power supply line Vdd. One end of the auxiliary capacitive element 16 is connected to the pixel electrode 10, and the other end thereof is connected to the power supply line Vdd. A cathode of the OLED element 14 is connected to a fixed potential (e.g., ground potential) having a different potential from the power supply line Vdd. As for the TFT 15 for driving the OLED element 14, one having the same conductivity as the TFT 13 may be provided between the cathode of the OLED element 14 and the fixed potential (e.g., ground potential).

When each pixel is configured as illustrated in the equivalent circuit of FIG. 16, the opposite electrode wiring CML connected to the common driver 6 can be replaced by the power supply line Vdd in the display device illustrated in FIG. 1.

Further, in the case of the organic EL display device, unlike the liquid crystal display device, the polarity inversion drive (frame inversion drive, dot inversion drive, column inversion drive, or the like) is not required. Thus, the polarity of the signal voltage that is applied to the source line SL is not changed in the vertical period Tv1 and the vertical period Tv2 in the frame inversion drive illustrated in FIG. 7, and the polarity of the signal voltage that is applied to the odd-numbered source lines SL1, SLm+1 and the polarity of the signal voltage that is applied to the even-numbered source lines SL2, SLm are set to be the same in the dot inversion drive or the column inversion drive illustrated in FIG. 7. Specifically, the signal voltage that is applied to all the source lines SL may be set to a positive voltage with the fixed potential (ground potential) as a reference in each of the scanning periods T1 of all the vertical periods Tv.

### EXPLANATION OF REFERENCES

1: Display Device
2: Liquid Crystal Panel
3: Display Control Circuit
4: Source Driver
5: Gate Driver
6: Common Driver
10: Pixel Electrode
11: Opposite Electrode
12: Unit Liquid Crystal Display Element (Unit Display Element)
13: Thin-film Transistor Element (TFT)
14: OLED (Organic LED) Element (Unit Display Element)
15: Thin-film Transistor Element (TFT)
16: Auxiliary Capacitive Element
20: Transistor Element
21: First Common Source Line
22: Second Common Source Line
23, 24: Selector
25: Intermediate Voltage Generating Circuit
CML: Opposite Electrode Wiring
Ct: Timing Signal
DA: Digital Image Signal
Dt: Timing Control Information
Dv: Data Signal
GL (GL1, GL2, GLn): Gate Line
Gtc: Scanning-side Timing Control Signal
Sec: Opposite Voltage Control Signal
SL (SL1, SL2, . . . SLm+1): Source Line
Stc: Data-side Timing Control Signal
T1: Scanning Period
T2: Non-scanning Period
Tv1, Tv2: Vertical Period
V0: Fixed Potential (Ground Potential)
V10: Pixel Voltage
Vcom: Opposite Voltage
Vdd: Power Supply Line
Vgn: Second Scanning Voltage
Vgp: First Scanning Voltage
Vhp, Vhn: Intermediate Voltage (Common Intermediate Voltage)
Vs0: Minimum Value of Signal Voltage (Absolute Value)
Vs1: Maximum Value of Signal Voltage (Absolute Value)

1. A data signal line driving circuit which separately drives a plurality of data signal lines of an active matrix pixel array, wherein
each pixel constituting the pixel array includes:
a unit display element that presents a different display state in accordance with a pixel voltage held in a pixel electrode; and
a thin-film transistor element including a first terminal, a second terminal, and a control terminal that controls conduction/non-conduction between the first and second terminals, the first terminal being electrically connected to the pixel electrode, the second terminal being electrically connected to any one of the plurality of data signal lines extending in a column direction, the control terminal being electrically connected to any one of a plurality of scanning signal lines extending in a row direction,
a scanning period is one successive period set within one vertical period when pixel data are written into all pixels of the pixel array, wherein the plurality of scanning signal lines are sequentially selected and the pixel data are written into the pixels connected to each sequentially selected scanning signal line,
a non-scanning period is another successive period set within the one vertical period, wherein the plurality of scanning signal lines are not selected and the pixel data written during the scanning period are separately held in the pixels, and
the data signal line driving circuit
applies a signal voltage corresponding to the pixel data having the same polarity to the same data signal line with a predetermined fixed potential as a reference regardless of an order of the selected scanning signal line in the scanning period, and
applies an intermediate voltage between a maximum value and a minimum value of pixel voltages to each of the data signal lines in the non-scanning period, the pixel voltages being respectively held in the pixel electrodes of the plurality of pixels connected to each of the data signal lines.

2. The data signal line driving circuit according to claim 1, wherein the unit display element is a unit liquid crystal display element formed by holding a liquid crystal layer between the pixel electrode and an opposite electrode.

3. The data signal line driving circuit according to claim 1, wherein
in the non-scanning period, one common intermediate voltage is applied to the data signal lines to which the signal voltages having the same polarity are applied in the scanning period, the one common intermediate voltage being set in accordance with the polarity, and
the common intermediate voltage is given as an average value of two pixel voltages corresponding to a maximum gradation and a minimum gradation of the pixel data, respectively.

4. The data signal line driving circuit according to claim 1, wherein
in the scanning period, the signal voltage having a positive polarity is applied to one of the two adjacent data signal lines with the fixed potential as a reference, while the signal voltage having a negative polarity is applied to the other of the two adjacent data signal lines with the fixed potential as the reference, and
in the scanning period in the subsequent one vertical period, the polarities of the signal voltages are inverted.

5. The data signal line driving circuit according to claim 1, wherein a length of the scanning period is not more than one-half of a length of the one vertical period.

6. The data signal line driving circuit according to claim 1, wherein the length of the scanning period within the one vertical period is shorter than 8.34 msec.

7. A display device comprising:
a pixel array in which a plurality of pixels are arranged in a row direction and a column direction, respectively, the plurality of pixels each including
a unit display element that presents a different display state in accordance with a pixel voltage held in a pixel electrode, and
a thin-film transistor element including a first terminal, a second terminal, a control terminal that controls conduction/non-conduction between the first and second terminals, the first terminal being electrically connected to the pixel electrode, the second terminal being electrically connected to any one of the plurality of data signal lines extending in the column direction, the control terminal being electrically connected to any one of a plurality of scanning signal lines extending in the row direction;
a data signal line driving circuit according to claim 1; and
a scanning signal line driving circuit, wherein
a scanning period is set within one vertical period when pixel data are written into all pixels of the pixel array, wherein the plurality of scanning signal lines are sequentially selected and the pixel data are written into the pixels connected to each sequentially selected scanning signal line,
a non-scanning period is set within the one vertical period, wherein the plurality of scanning signal lines are not selected and the pixel data written during the scanning period are separately held in the pixels, and
the scanning signal line driving circuit
applies a first scanning voltage that sets the thin-film transistor element to a conducting state to the selected scanning signal line and a second scanning voltage that sets the thin-film transistor element to a non-conducting state to an unselected scanning signal line in the scanning period, and
applies a non-scanning voltage that sets the thin-film transistor element to a non-conducting state to all of the scanning signal lines.

8. The display device according to claim 7, wherein
the unit display element is a unit liquid crystal display element formed by holding a liquid crystal layer between the pixel electrode and an opposite electrode, and
the display device includes an opposite electrode driving circuit which supplies the opposite electrode with a counter electrode voltage fixed within a predetermined voltage range with the fixed potential as a reference throughout a successive plurality of vertical periods.

9. The display device according to claim 8, wherein the pixel is- provided without an auxiliary capacitive element having one end connected to the pixel electrode.

10. The display device according to claim 7, comprising
a display control circuit which receives timing control information in accordance with an attribute of an image displayed in the pixel array, and sets a length of at least one of the scanning period and the non-scanning period based on the timing control information, to perform timing control on the data signal line driving circuit and the scanning signal line driving circuit based on the set scanning period and non-scanning period.

11. The display device according to claim 7, comprising
the scanning signal lines the number of which is equal to the number of rows of the pixel array, and the data signal lines the number of which is greater by one than the number of columns of the pixel array, wherein
in each of the pixels arranged in the same row of the pixel array, the control terminal of the thin-film transistor element is connected to the scanning signal line in the same row order as the relevant row,
in each of the pixels arranged in the same column of the pixel array in one of odd-numbered and even-numbered row orders, the second terminal of the thin-film transistor element is connected to the data signal line in the same column order as the relevant column, and
in each of the pixels arranged in the same column of the pixel array in the other of odd-numbered and even-numbered row orders, the second terminal of the thin-film transistor element is connected to the data signal line in a column order greater by one than the same column order as the relevant column.

12. The display device according to claim 7, comprising
the scanning signal lines the number of which is equal to the number of rows of the pixel arrays and the data signal lines the number of which is equal to the number of columns of the pixel arrays, wherein
in each of the pixels arranged in the same row of the pixel array, the control terminal of the thin-film transistor element is connected to the scanning signal line in the same row order as the relevant row, and
in each of the pixels arranged in the same column of the pixel array, the second terminal of the thin-film transistor element is connected to the data signal line in the same column order as the relevant column.

13. A method of driving a plurality of data signal lines of an active matrix pixel array separately, wherein
each pixel constituting the pixel array includes:
a unit display element that presents a different display state in accordance with a pixel voltage held in a pixel electrode; and
a thin-film transistor element including a first terminal, a second terminal, and a control terminal that controls conduction/non-conduction between the first and second terminals, the first terminal being electrically connected to the pixel electrode, the second terminal being electrically connected to any one of the plurality of data signal lines extending in a column direction, the control terminal being electrically connected to any one of a plurality of scanning signal lines extending in a row direction,
a scanning period is one successive period set within one vertical period when pixel data are written into all pixels of the pixel array, wherein the plurality of scanning signal lines are sequentially selected and the pixel data are written into the pixels connected to each sequentially selected scanning signal line,
a non-scanning period is another successive period set within the one vertical period, wherein the plurality of scanning signal lines are not selected and the pixel data written during the scanning period are separately held in the pixels, and
the method includes:
applying a signal voltage corresponding to the pixel data having the same polarity to the same data signal line with a predetermined fixed potential as a reference regardless of an order of the selected scanning signal line in the scanning period; and
applying an intermediate voltage between a maximum value and a minimum value of pixel voltages to each of the data signal lines in the non-scanning period, the pixel voltages being respectively held in the pixel electrodes of the plurality of pixels connected to each of the data signal lines.

14. The method according to claim 13, wherein the unit display element is a unit liquid crystal display element formed by holding a liquid crystal layer between the pixel electrode and an opposite electrode.

15. The method according to claim 13, including
applying one common intermediate voltage to the data signal lines, to which the signal voltages having the same polarity are applied in the scanning period, in the non-scanning period, the one common intermediate voltage being set in accordance with the polarity, wherein
the common intermediate voltage is given as an average value of two pixel voltages corresponding to a maximum gradation and a minimum gradation of the pixel data, respectively.

16. The method according to claim 13, including:
applying the signal voltage having a positive polarity to one of the two adjacent data signal lines with the fixed potential as a reference, and applying the signal voltage having a negative polarity to the other of the two adjacent data signal lines with the fixed potential as the reference, in the scanning period; and
inverting the polarities of the signal voltages in the scanning period in the subsequent one vertical period.

17. The method according to claim 13, wherein a length of the scanning period is not more than one-half of a length of the one vertical period.

18. The method according to claim 13, wherein the length of the scanning period within the one vertical period is shorter than 8.34 msec.

19. The method according to claim 13, including:
receiving timing control information in accordance with an attribute of an image displayed in the pixel array; and
setting a length of at least any one of the scanning period and the non-scanning period based on the timing control information.
